(19) United States
(12) Patent Application Publication
(10) Pub. No.: US 2025/0358810 A1
(43) Pub. Date: Nov. 20, 2025

(54) INFORMATION TRANSMISSION METHOD, AND APPARATUS

(71) Applicant: HUAWEI TECHNOLOGIES CO., LTD., Shenzhen (CN)

(72) Inventors: Youlong Cao, Shanghai (CN); Rui Xu, Shanghai (CN); Erkai Chen, Bonn (DE); Yi Qin, Shanghai (CN); Xiang Mi, Boulogne Billancourt (FR)

(73) Assignee: HUAWEI TECHNOLOGIES CO., LTD., Shenzhen (CN)

(21) Appl. No.: 19/285,460

(22) Filed: Jul. 30, 2025

Related U.S. Application Data
(63) Continuation of application No. PCT/CN2024/074753, filed on Jan. 30, 2024.

(30) Foreign Application Priority Data
Feb. 14, 2023 (CN) 202310139593.9

(51) Int. Cl. H04W 72/12; H04W 28/02; H04W 72/0446

(52) U.S. Cl. CPC H04W 72/12; H04W 28/0278; H04W 72/0446

(57) ABSTRACT

An information transmission method and an apparatus. First configuration information used to configure a reporting periodicity of first indication information is obtained. The first indication information is sent on at least one configured grant (configured grant, CG) transmission occasion within a CG period based on the reporting periodicity. The first indication information indicates a CG transmission occasion that is unused within the CG period or a CG transmission occasion that is used within the CG period.

### CROSS-REFERENCE TO RELATED APPLICATIONS

This application is a continuation of International Application No. PCT/CN2024/074753, filed on Jan. 30, 2024, which claims priority to Chinese Patent Application No. 202310139593.9, filed on Feb. 14, 2023. The disclosures of the aforementioned applications are hereby incorporated by reference in their entireties.

### BACKGROUND

In a communication system, a base station may configure a configured grant (configured grant, CG) transmission occasion within a CG period for a terminal in a CG manner. Subsequently, the terminal may periodically send to-be-sent data to the base station by using the CG transmission occasion. Sizes of data that can be carried on CG transmission occasions within different CG periods are the same, and sizes of to-be-sent data within the different CG periods may be different. Therefore, to ensure that to-be-sent data within each CG period is carried on a corresponding CG transmission occasion, the base station usually configures a large quantity of CG transmission occasions for the terminal within one CG period, leading to a waste of resources.

### SUMMARY

At least one embodiment provides an information transmission method and an apparatus, so that a terminal can report, based on a configured reporting periodicity, a CG transmission occasion that is unused within a CG period to a base station, thereby saving resources.

To achieve the foregoing objective, the following technical solutions are used in at least one embodiment.

According to a first aspect, an information transmission method is provided. The method may be performed by a terminal; or may be performed by a module used in the terminal, for example, a chip, a chip system, or a circuit; or may be implemented by a logical node, a logical module, or software that can implement all or some functions of the terminal. This is not limited herein. For ease of description, an example in which the method is performed by the terminal is used for description below. The method includes: obtaining first configuration information, where the first configuration information is used to configure a reporting periodicity of first indication information, and the first indication information indicates a configured grant CG transmission occasion that is unused within a CG period or a CG transmission occasion that is used within a CG period; and sending the first indication information on at least one CG transmission occasion within the CG period based on the reporting periodicity.

According to the method provided in the first aspect, the terminal may obtain the reporting periodicity of the first indication information, and send the first indication information based on the reporting periodicity. In this way, a node that receives the first indication information, for example, a radio access network (radio access network, RAN) node, may determine, based on the first indication information, the CG transmission occasion that is unused within the CG period, thereby saving resources. For example, the RAN node may reallocate the unused CG transmission occasion, for example, allocate the unused CG transmission occasion to another service of the terminal in a configured scheduling (configured scheduling, CS) manner, or allocate the unused CG transmission occasion to another terminal other than this terminal.

In at least one embodiment, the reporting periodicity is N+1 or N, N represents a quantity of CG transmission occasions between two adjacent CG transmission occasions on which the first indication information is carried within the CG period, and N is an integer greater than or equal to 0; or the reporting periodicity is T, and T represents a time difference between two adjacent CG transmission occasions on which the first indication information is carried within the CG period.

Based on at least one embodiment, the terminal may report the first indication information based on N, N+1, or T, to improve flexibility of reporting the first indication information by the terminal.

In at least one embodiment, the first configuration information is further used to configure a 1^{st} CG transmission occasion on which the first indication information is carried within the CG period.

Based on at least one embodiment, the first configuration information may be used to configure a start CG transmission occasion on which the first indication information is carried within the CG period, to adjust time at which the terminal sends the first indication information. For example, the start CG transmission occasion is configured, so that the terminal delays sending the first indication information. For example, the terminal sends the first indication information after receiving a tail packet indicator, thereby reducing signaling overheads.

In at least one embodiment, the at least one CG transmission occasion includes a first CG transmission occasion and a second CG transmission occasion, and the first CG transmission occasion precedes the second CG transmission occasion; and a quantity of unused CG transmission occasions indicated by the first indication information carried on the first CG transmission occasion is M1, a quantity of unused CG transmission occasions indicated by the first indication information carried on the second CG transmission occasion is M2, and M1 is less than M2; or a quantity of used CG transmission occasions indicated by the first indication information carried on the first CG transmission occasion is M3, a quantity of used CG transmission occasions indicated by the first indication information carried on the second CG transmission occasion is M4, and M3 is greater than M4.

Based on at least one embodiment, within the CG period, a quantity of unused CG transmission occasions indicated by the first indication information sent earlier is less than a quantity of unused CG transmission occasions indicated by the first indication information sent later; or within the CG period, a quantity of used CG transmission occasions indicated by the first indication information sent earlier is greater than a quantity of used CG transmission occasions indicated by the first indication information sent later. In this way, after the RAN node reallocates the unused CG transmission occasions, the terminal is able to avoid indicating these CG transmission occasions need to be used, leading to related interference between terminals.

In at least one embodiment, the quantity of unused CG transmission occasions or the quantity of used CG transmission occasions is related to a buffer state of the terminal.

Based on at least one embodiment, the terminal may determine, based on the buffer state of the terminal, a quantity of CG transmission occasions that are unused within the CG period or a quantity of CG transmission occasions that are used within the CG period. This implementation is simple.

In at least one embodiment, the first configuration information is further used to configure a first interval, the at least one CG transmission occasion includes a third CG transmission occasion, the first indication information carried on the third CG transmission occasion indicates that the unused CG transmission occasions include a fourth CG transmission occasion, and there is the first interval between the third CG transmission occasion and the fourth CG transmission occasion.

Based on at least one embodiment, the first indication information may indicate that a CG transmission occasion that has the first interval from a CG transmission occasion on which the first indication information is carried is unused, to reserve time for the RAN node to reallocate the unused CG transmission occasion.

In at least one embodiment, the unused CG transmission occasions further include a CG transmission occasion following the fourth CG transmission occasion within the CG period.

Based on at least one embodiment, in response to the first indication information indicating that the fourth CG transmission occasion is unused, the RAN node may determine that the CG transmission occasion following the fourth CG transmission occasion is unused either. In this way, the first indication information may not need to indicate whether the CG transmission occasion following the fourth CG transmission occasion is used.

In at least one embodiment, an interval between each CG transmission occasion of the at least one CG transmission occasion and a CG transmission occasion that is unused within the CG period is greater than a first threshold.

Based on at least one embodiment, time may be reserved for the RAN node to reallocate the CG transmission occasion that is unused within the CG period.

In at least one embodiment, the first configuration information is further used to configure the first threshold.

Based on at least one embodiment, the first configuration information may be used to configure a minimum interval between each CG transmission occasion of the at least one CG transmission occasion and a CG transmission occasion that is unused within the CG period, so that the terminal reports the first indication information based on the minimum interval. In this way, the RAN node may have sufficient time to reallocate the CG transmission occasion that is unused within the CG period.

In at least one embodiment, the first configuration information is further used to configure a CG transmission occasion within the CG period.

Based on at least one embodiment, the first configuration information may further be used to configure the CG transmission occasion within the CG period, so that the terminal performs data transmission by using the configured CG transmission occasion.

According to a second aspect, an information transmission method is provided. The method may be performed by a RAN node; or may be performed by a module used in the RAN node, for example, a chip, a chip system, or a circuit; or may be implemented by a logical node, a logical module, or software that can implement all or some functions of the RAN node. This is not limited herein. For ease of description, an example in which the method is performed by the RAN node is used for description below. The method includes: outputting first configuration information, where the first configuration information is used to configure a reporting periodicity of first indication information, and the first indication information indicates a configured grant CG transmission occasion that is unused within a CG period or a CG transmission occasion that is used within a CG period; and receiving the first indication information on at least one CG transmission occasion within the CG period based on the reporting periodicity.

According to the method provided in the second aspect, the RAN node may configure the reporting periodicity of the first indication information, and receive the first indication information based on the reporting periodicity, to determine, based on the first indication information, the CG transmission occasion that is unused within the CG period, thereby saving resources. For example, the RAN node may reallocate the unused CG transmission occasion, for example, allocate, in a CS manner, the unused CG transmission occasion to another service of the terminal that reports the first indication information, or allocate the unused CG transmission occasion to another terminal other than this terminal.

In at least one embodiment, the reporting periodicity is N+1 or N, N represents a quantity of CG transmission occasions between two adjacent CG transmission occasions on which the first indication information is carried within the CG period, and N is an integer greater than or equal to 0; or the reporting periodicity is T, and T represents a time difference between two adjacent CG transmission occasions on which the first indication information is carried within the CG period.

Based on at least one embodiment, the RAN node may configure that the terminal reports the first indication information based on N, N+1, or T, to improve flexibility of reporting the first indication information by the terminal.

In at least one embodiment, the first configuration information is further used to configure a 1^{st} CG transmission occasion on which the first indication information is carried within the CG period.

Based on at least one embodiment, the first configuration information may be used to configure a start CG transmission occasion on which the first indication information is carried within the CG period, to adjust time at which the terminal sends the first indication information. For example, the start CG transmission occasion is configured, so that the terminal delays sending the first indication information. For example, the terminal sends the first indication information after receiving a tail packet indicator, thereby reducing signaling overheads.

In at least one embodiment, the at least one CG transmission occasion includes a first CG transmission occasion and a second CG transmission occasion, and the first CG transmission occasion precedes the second CG transmission occasion; and a quantity of unused CG transmission occasions indicated by the first indication information carried on the first CG transmission occasion is M1, a quantity of unused CG transmission occasions indicated by the first indication information carried on the second CG transmission occasion is M2, and Ml is less than M2; or a quantity of used CG transmission occasions indicated by the first indication information carried on the first CG transmission occasion is M3, a quantity of used CG transmission occasions indicated by the first indication information carried on the second CG transmission occasion is M4, and M3 is greater than M4.

Based on at least one embodiment, within the CG period, a quantity of unused CG transmission occasions indicated by the first indication information sent earlier is less than a quantity of unused CG transmission occasions indicated by the first indication information sent later; or within the CG period, a quantity of used CG transmission occasions indicated by the first indication information sent earlier is greater than a quantity of used CG transmission occasions indicated by the first indication information sent later. In this way, after the RAN node reallocates the unused CG transmission occasions, the terminal is able to avoid indicating these CG transmission occasions are to be used, leading to related interference between terminals.

In at least one embodiment, the first configuration information is further used to configure a first interval, the at least one CG transmission occasion includes a third CG transmission occasion, the first indication information carried on the third CG transmission occasion indicates that the unused CG transmission occasions include a fourth CG transmission occasion, and there is the first interval between the third CG transmission occasion and the fourth CG transmission occasion.

Based on at least one embodiment, the first indication information may indicate that a CG transmission occasion that has the first interval from a CG transmission occasion on which the first indication information is carried is unused, to reserve time for the RAN node to reallocate the unused CG transmission occasion.

In at least one embodiment, the unused CG transmission occasions further include a CG transmission occasion following the fourth CG transmission occasion within the CG period.

Based on at least one embodiment, in response to the first indication information indicating that the fourth CG transmission occasion is unused, the RAN node may determine that the CG transmission occasion following the fourth CG transmission occasion is unused either. In this way, the first indication information may not need to indicate whether the CG transmission occasion following the fourth CG transmission occasion is used.

In at least one embodiment, an interval between each CG transmission occasion of the at least one CG transmission occasion and a CG transmission occasion that is unused within the CG period is greater than a first threshold.

Based on at least one embodiment, time may be reserved for the RAN node to reallocate the CG transmission occasion that is unused within the CG period.

In at least one embodiment, the first configuration information is further used to configure the first threshold.

Based on at least one embodiment, the first configuration information may be used to configure a minimum interval between each CG transmission occasion of the at least one CG transmission occasion and a CG transmission occasion that is unused within the CG period, so that the terminal reports the first indication information based on the minimum interval. In this way, the RAN node may have sufficient time to reallocate the CG transmission occasion that is unused within the CG period.

In at least one embodiment, the first configuration information is further used to configure a CG transmission occasion within the CG period.

Based on at least one embodiment, the first configuration information may further be used to configure the CG transmission occasion within the CG period, so that the terminal performs data transmission by using the configured CG transmission occasion.

According to a third aspect, a communication apparatus is provided, to implement the foregoing methods. The communication apparatus may be the terminal in the first aspect, an apparatus including the terminal, or a module in the terminal in the first aspect, for example, a chip, a chip system, or a circuit; or may be a logical node, a logical module, or a software implementation that can implement some or all functions of the terminal. Alternatively, the communication apparatus may be the RAN node in the second aspect, an apparatus including the RAN node, or a module in the RAN node in the second aspect, for example, a chip, a chip system, or a circuit; or may be a logical node, a logical module, or a software implementation that can implement some or all functions of the RAN node. The communication apparatus includes a corresponding module, unit, or means (means) for implementing the foregoing methods. The module, unit, or means may be implemented by hardware, software, or hardware executing corresponding software. The hardware or the software includes one or more modules or units corresponding to the foregoing functions.

With reference to the third aspect, in at least one embodiment, the communication apparatus may include a processing module and an interface module. The processing module may be configured to implement a processing function in any one of the foregoing aspects and at least one embodiment. The processing module may be, for example, a processor. The interface module may also be referred to as an interface unit, and is configured to implement a sending function and/or a receiving function in any one of the foregoing aspects and at least one embodiment. The interface module may include an interface circuit, a transceiver machine, a transceiver, or a communication interface.

With reference to the third aspect, in at least one embodiment, the interface module includes a sending module and a receiving module that are respectively configured to implement the sending and receiving functions in any one of the foregoing aspects and at least one embodiment.

According to a fourth aspect, a communication apparatus is provided, and includes a processor. The processor is configured to: be coupled to a memory, and after reading instructions in the memory, perform the method according to any one of the foregoing aspects based on the instructions. The communication apparatus may be the terminal in the first aspect, an apparatus including the terminal, or a module in the terminal in the first aspect, for example, a chip, a chip system, or a circuit; or may be a logical node, a logical module, or a software implementation that can implement some or all functions of the terminal. Alternatively, the communication apparatus may be the RAN node in the second aspect, an apparatus including the RAN node, or a module in the RAN node in the second aspect, for example, a chip, a chip system, or a circuit; or may be a logical node, a logical module, or a software implementation that can implement some or all functions of the RAN node.

With reference to the fourth aspect, in at least one embodiment, the communication apparatus further includes a memory. The memory is configured to store necessary program instructions and data.

With reference to the fourth aspect, in at least one embodiment, the communication apparatus is a chip or a chip system. Optionally, in response to the communication apparatus being a chip system, the communication apparatus may include a chip, or may include a chip and another discrete component.

According to a fifth aspect, a communication apparatus is provided, and includes a processor and an interface circuit. The interface circuit is configured to receive a computer program or instructions, and transmit the computer program or the instructions to the processor. The processor is configured to execute the computer program or the instructions, to enable the communication apparatus to perform the method according to any one of the foregoing aspects. The communication apparatus may be the terminal in the first aspect, an apparatus including the terminal, or a module in the terminal in the first aspect, for example, a chip, a chip system, or a circuit; or may be a logical node, a logical module, or a software implementation that can implement some or all functions of the terminal. Alternatively, the communication apparatus may be the RAN node in the second aspect, an apparatus including the RAN node, or a module in the RAN node in the second aspect, for example, a chip, a chip system, or a circuit; or may be a logical node, a logical module, or a software implementation that can implement some or all functions of the RAN node.

With reference to the fifth aspect, in at least one embodiment, the communication apparatus is a chip or a chip system. Optionally, in response to the communication apparatus being a chip system, the communication apparatus may include a chip, or may include a chip and another discrete component.

According to a sixth aspect, a computer-readable storage medium is provided. The computer-readable storage medium stores instructions, and in response to the instructions being run on a computer, the computer is enabled to perform the method according to any one of the foregoing aspects.

According to a seventh aspect, a computer program product including instructions is provided. In response to the computer program product running on a computer, the computer is enabled to perform the method according to any one of the foregoing aspects.

According to an eighth aspect, a communication system is provided. The communication system includes the terminal configured to perform the method in the first aspect and the RAN node configured to perform the method in the second aspect.

For technical effects achieved by at least one embodiment of the third aspect to the eighth aspect, refer to technical effects achieved by any one of the first aspect, the second aspect, or different embodiments of the first aspect or the second aspect. Details are not described herein again.

The solutions in the foregoing aspects may be combined on a premise that the solutions are not contradictory.

### BRIEF DESCRIPTION OF DRAWINGS

FIG. 1A is a first diagram of CG resources;

FIG. 1B is a second diagram of CG resources;

FIG. 2 is a diagram of an architecture of a communication system according to at least one embodiment;

FIG. 3 is a diagram of a hardware structure of a communication apparatus according to at least one embodiment;

FIG. 4 is a schematic flowchart of an information transmission method according to at least one embodiment;

FIG. 5A is a first diagram of a reporting periodicity of first indication information according to at least one embodiment;

FIG. 5B is a second diagram of a reporting periodicity of first indication information according to at least one embodiment;

FIG. 6A is a first diagram of a CG transmission opportunity on which first indication information is carried according to at least one embodiment;

FIG. 6B is a second diagram of a CG transmission opportunity on which first indication information is carried according to at least one embodiment; and

FIG. 7 is a diagram of a structure of a communication apparatus according to at least one embodiment.

### DESCRIPTION OF EMBODIMENTS

Before the technical solutions of at least one embodiment are described, related technical terms and procedures in at least one embodiment are explained and described. The explanations and descriptions are intended to facilitate understanding of embodiments of at least one embodiment, but should not be construed as a limitation on the protection scope claimed in at least one embodiment.

### 1. Extended Reality (Extended Reality, XR)

The XR may refer to a combination of real and virtual environments generated by using computing technologies and wearable devices, and human-machine interaction. The XR has advantages such as a plurality of views and strong interactivity, can provide brand-new experience for a user, and has a great application value and a great commercial potential. The XR mainly includes virtual-reality interaction technologies, for example, virtual reality (virtual reality, VR) and augmented reality (augmented reality, AR), and can be widely applied to many fields such as entertainment, gaming, medical care, advertising, industry, online education, and engineering. The following describes the VR technology and the AR technology separately.

In the VR technology, a plurality of technologies such as computer graphics and multimedia are integrated, to simulate functions of human sensory organs such as visual, auditory, and tactile senses. In this way, people immerse in a virtual world generated by a computer, feel as in response to they being there, and perform real-time communication by using a language, a gesture, and the like. This enhances immersion. By using the VR technology, people feel verisimilitude of the real world, and can further break through restrictions such as time and space, to have wonderful experience of entering the virtual world. The VR technology usually requires the user to wear an XR terminal (for example, a head-mounted device) to simulate a visual and/or auditory and/or tactile sense of the user. The VR technology may be further used to perform action tracking on the user, to update simulated visual and/or auditory and/or tactile content in a timely manner. For example, in the VR technology, state information (for example, location information and posture information of a user) of a user may be processed, to display, on the XR terminal, scenario content corresponding to the state information of the user.

In the AR technology, by using a computer technology, virtual information is superimposed to the real world, is displayed through devices such as a mobile phone, a tablet computer, and glasses, and is perceived by people. In this way, integration of reality and virtuality is achieved, and the real world is enriched. In short, more information is given to a real object, to enhance a stereoscopic sense, and enhance a visual effect and interactive experience. For example, in the AR technology, perceived visual information (usually, the visual information includes depth information) may be processed, so that virtual information is integrated with the real world and is perceived by a user, thereby implementing “enhancement” of the real world.

From the foregoing descriptions of the VR technology and the AR technology, to implement effect of VR or AR, information (for example, state information or perceived visual information of a user) in the real world needs to be processed. In response to all these processing processes being performed on the terminal, a calculation amount of the terminal is increased, which is contrary to a market requirement for implementing terminal lightweight and improving terminal mobility.

To resolve this problem, a solution is proposed to apply concepts and technologies of cloud computing and cloud rendering to an XR service.

### 2. Cloud Virtual Reality (Cloud VR) and Cloud Augmented Reality (Cloud AR)

The cloud virtual reality is to apply concepts and technologies of cloud computing and cloud rendering to a VR service. The cloud augmented reality is to apply concepts and technologies of cloud computing and cloud rendering to an AR service. In both the cloud virtual reality and the cloud augmented reality, real-world information perceived by a terminal can be sent to a cloud through a high-speed and stable network (for example, sent to the cloud through a base station). The cloud processes the received information to obtain encoded and compressed information such as a display output and an audio output, and sends the information to the terminal through the high-speed and stable network (for example, send the information to the terminal through a base station). In this way, cloud-based delivery and cloud rendering of VR/AR service content are implemented, to meet a market requirement for implementing terminal lightweight and mobility.

In a video transmission service, for example, in a process in which the terminal sends perceived information in the real world to the cloud, or in a process in which the cloud sends, to the terminal, encoded and compressed information such as a display output and a sound output that are obtained through processing, to-be-sent data is usually periodically sent based on a frame rate, and a data amount is usually large. For example, for a video with a frame rate of 60 frames per second (frame per second, FPS), each video frame arrives at an interval of 16.67 milliseconds (ms). In response to the video frame being a 4K video frame, a size of the video frame is approximately 30 KB to 100 KB. In addition, sizes of different video frames are usually variable, and due to different compression ratios and frame types of different video frames, sizes of the different video frames differ greatly.

The cloud virtual reality and the cloud augmented reality have different characteristics, and therefore, service models of the cloud virtual reality and the cloud augmented reality are different. Specifically, in a cloud virtual reality service, a change of scenario content display is related to a posture or a location (action) of a user. Therefore, the terminal mainly sends location information and posture information of the user to the cloud, a data amount is small, and an uplink rate of the network is approximately tens of kbit/s. The cloud mainly sends a rendered video stream to the terminal, a data amount is large, and a downlink rate of the network may reach tens to hundreds of Mbit/s. Different from that of the cloud virtual reality service, a change of scene content display of a cloud augmented reality service is related to a change of a gaze focusing target of a user and a change of a spatial relationship (for example, a change of a spatial relationship caused by a user action) between a location and the gaze focusing target of the user. Therefore, the terminal mainly sends perceived visual information (the visual information includes depth information) to the cloud, for example, a clear and stable picture or video stream, or environment feature information extracted from the visual information, and a data amount is large. For example, usually, a network uplink rate needed for initial experience of the cloud augmented reality service is approximately 2 Mbit/s, and a network uplink rate needed for advanced experience is approximately 10 Mbit/s to 20 Mbit/s. A size of data sent by the cloud to the terminal is small. In conclusion, the cloud virtual reality service has a high requirement on a downlink transmission rate, and the cloud augmented reality service has a high requirement on an uplink transmission rate.

### 3. CG

A RAN node may configure a periodic uplink resource for a terminal in a CG manner. The terminal may periodically and repeatedly use the uplink resource to perform uplink transmission. For example, the RAN node may configure the periodic uplink resource for the terminal in the following manner 1 or manner 2.

Manner 1 specifically includes the following step.

S3.1: The RAN node outputs second configuration information. Correspondingly, the terminal obtains the second configuration information.

That the RAN node outputs the second configuration information may be understood as that the RAN node sends the second configuration information to another apparatus. For example, the RAN node sends the second configuration information to the terminal. Alternatively, that the RAN node outputs the second configuration information may be understood as that the RAN node implementing some functions of a base station outputs the second configuration information to another RAN node implementing some functions of the base station. For example, a distributed unit (distributed unit, DU) outputs the second configuration information to a radio unit (radio unit, RU).

That the terminal obtains the second configuration information may be understood as that the terminal receives the second configuration information from another apparatus. For example, the terminal receives the second configuration information from the RAN node. Alternatively, that the terminal obtains the second configuration information may be understood as that a module of the terminal obtains the second configuration information from another module of the terminal. For example, a baseband processing module of the terminal may restore a baseband signal from a radio frequency module, and then decode the baseband signal to obtain the second configuration information.

The second configuration information is used to configure and activate a CG resource. For example, the second configuration information includes information about a CG periodicity, information about a plurality of CG transmission occasions (CG occasions) within one CG period, and the like. In at least one embodiment, the CG transmission occasion may be understood as a CG time frequency resource or a CG time domain resource, and is used for transmission of uplink data. Optionally, the second configuration information further includes a piece of indication information, and the indication information indicates to activate the CG resource.

In at least one embodiment, the second configuration information is carried in a radio resource control (radio resource control, RRC) message.

In at least one embodiment, the CG transmission occasion may be further named in another manner, for example, a CG transmission opportunity, a CG physical uplink shared channel (physical uplink shared channel, PUSCH) transmission opportunity, or a CG PUSCH transmission occasion. This is not limited.

After obtaining the second configuration information, the terminal may periodically use the foregoing plurality of CG transmission occasions to perform uplink transmission.

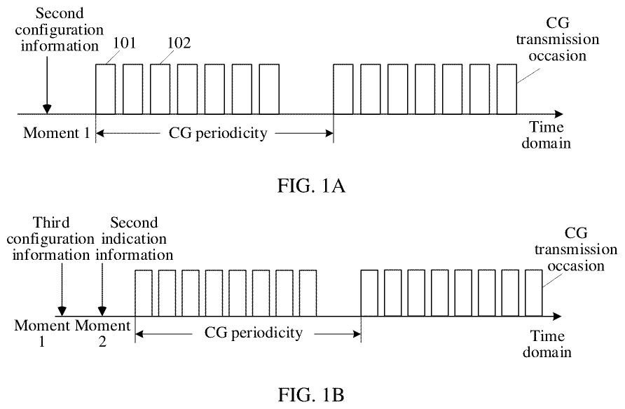

In an example, the CG resource configured and activated based on the second configuration information may be shown in FIG. 1A. FIG. 1A shows CG transmission occasions within two CG periods. In FIG. 1A, the RAN node sends the second configuration information to the terminal at moment 1. The second configuration information is used to configure the CG periodicity and seven CG transmission occasions within one CG period. After receiving the second configuration information, the terminal may send data to the RAN node within each CG period by using CG transmission occasions within the CG period.

Manner 2 specifically includes the following steps.

S3a: The RAN node outputs the third configuration information. Correspondingly, the terminal obtains the third configuration information.

A meaning of outputting the third configuration information by the RAN node is similar to a meaning of outputting the second configuration information by the RAN node. Refer to the foregoing descriptions of outputting the second configuration information by the RAN node. Details are not described herein again.

A meaning of obtaining the third configuration information by the terminal is similar to a meaning of obtaining the second configuration information by the terminal. Refer to the foregoing descriptions of obtaining the second configuration information by the terminal. Details are not described herein again.

The third configuration information is used to configure a CG resource. For example, the third configuration information includes information about a CG periodicity, information about a plurality of CG transmission occasions within one CG period.

In at least one embodiment, the third configuration information is carried in an RRC message.

S3b: The RAN node outputs second indication information. Correspondingly, the terminal obtains the second indication information.

A meaning of outputting the second indication information by the RAN node is similar to a meaning of outputting the second configuration information by the RAN node. Refer to the foregoing descriptions of outputting the second configuration information by the RAN node. Details are not described herein again.

A meaning of obtaining the second indication information by the terminal is similar to a meaning of obtaining the second configuration information by the terminal. Refer to the foregoing descriptions of obtaining the second configuration information by the terminal. Details are not described herein again.

The second indication information indicates to activate the CG resource configured based on the third configuration information.

In at least one embodiment, the second indication information is carried in downlink control information (downlink control information, DCI).

After obtaining the third configuration information and the second indication information, the terminal may periodically use the plurality of CG transmission occasions that are configured based on the third configuration information, to perform uplink transmission.

In an example, the CG resource configured based on the third configuration information may be shown in FIG. 1B. FIG. 1B shows CG transmission occasions within two CG periods. In FIG. 1B, the RAN node sends the third configuration information to the terminal at moment 1, and sends the second indication information to the terminal at moment 2 after moment 1. The third configuration information is used to configure the CG periodicity and eight CG transmission occasions within one CG period. After receiving the third configuration information and the second indication information, the terminal may send data to the RAN node within each CG period by using CG transmission occasions within the CG period.

The foregoing descriptions that, in a CG manner, the RAN node may configure a periodically repeated CG resource for the terminal through one time of resource allocation. Therefore, sizes of data that can be carried by CG resources within different CG periods are the same. For example, in FIG. 1A, sizes of data that can be carried by first seven CG transmission opportunities are the same as sizes of data that can be carried by later seven CG transmission opportunities. Sizes of to-be-sent data within different CG periods may be different. For example, as described above in response to the cloud virtual reality and the cloud augmented reality being described, the sizes of the different video frames are usually variable, and due to the different compression ratios and frame types of the different video frames, the sizes of the different video frames differ greatly. As a result, a size of to-be-sent data within a CG period (for example, a CG period 1) is large, and a size of to-be-sent data within a CG period (for example, a CG period 2) is small. In this case, in the CG period 1, the to-be-sent data may occupy all CG transmission occasions within the period, and resources within the period are not wasted. However, within the CG period 2, the to-be-sent data may occupy some CG transmission occasions within the period, and a CG transmission occasion that is not occupied by the to-be-sent data within the period is not used for data transmission, and is wasted.

To save resources, the terminal reports a CG transmission occasion that is unused within a CG period to the RAN node, so that the RAN node reallocates the unused CG transmission occasion, for example, allocates, in a CS manner, the unused CG transmission occasion to another service of the terminal, or allocates the unused CG transmission occasion to another terminal. Specifically, the terminal may report, according to a predefined rule, a CG transmission occasion that is unused within the CG period to the RAN node; or the RAN node configures, for the terminal, a manner of reporting the CG transmission occasion that is unused within the CG period, and the terminal reports, based on the manner configured by the RAN node, the CG transmission occasion that is unused within the CG period to the RAN node.

For example, at least one embodiment provides the following three information transmission methods. By using any one of the following three methods, a terminal may report, to a RAN node, a CG transmission occasion that is unused within a CG period, thereby saving resources.

Method 1: The terminal sends third indication information to the RAN node on each CG transmission occasion within a CG period. Correspondingly, the RAN node receives the third indication information on each CG transmission occasion within the CG period. The third indication information indicates a CG transmission occasion that is unused within the CG period. Optionally, the third indication information is carried in uplink control information (uplink control information, UCI).

In the method 1, in response to there being to-be-sent data that needs to be sent by the terminal, the terminal reports, on each CG transmission occasion within the CG period, the CG transmission occasion that is unused within the CG period. In this way, although the RAN node can allocate the unused CG transmission occasion in a timely manner to save resources, repeated reporting for a plurality of times may occur. In addition, in response to the third indication information being carried in the UCI, The UCI is multiplexed to a PUSCH for transmission. However, transmission reliability of the UCI is higher than transmission reliability of the PUSCH. Therefore, during channel coding, a code rate of the UCI is lower than a code rate of the PUSCH. Therefore, multiplexing the UCI on each CG transmission occasion within the CG period leads to a waste of resources. In addition, the RAN node needs to perform blind detection on the UCI, leading to increased complexity of the RAN node.

Method 2: The terminal sends fourth indication information to the RAN node on a 1^{st} CG transmission occasion within a CG period. Correspondingly, the RAN node receives the fourth indication information on the 1^{st} CG transmission occasion within the CG period. The fourth indication information indicates a CG transmission occasion that is unused within the CG period. Optionally, the fourth indication information is carried in UCI.

IN the method 2, in response to there being to-be-sent data that needs to be sent by the terminal, the terminal reports, on the 1^{st} CG transmission occasion within the CG period, the CG transmission occasion that is unused within the CG period. In this way, the RAN node can allocate the unused CG transmission occasion in a timely manner to save resources, but inaccurate reporting may occur. For example, in response to not all to-be-sent data within one CG period arriving before the 1^{st} CG transmission occasion within the CG period, the terminal cannot accurately determine the CG transmission occasion that is unused within the CG period. For example, one CG transmission occasion can be used for transmission of one data packet. For the CG resources shown in FIG. 1A, transmission of a maximum of seven data packets can be performed within one CG periodicity. In response to there being five data packets to be sent within a 1^{st} CG period in FIG. 1A, where three data packets arrive before a CG transmission occasion 101, and the other two data packets arrive on a CG transmission occasion 102 in FIG. 1A, the terminal reports, on the CG transmission occasion 101, that a quantity of CG transmission occasions that are unused within the CG period is four. Actually, the quantity of CG transmission occasions that are unused within the CG period should be two. In addition, in response to the terminal reporting, on the CG transmission occasion 101, that the quantity of CG transmission occasions that are unused within the CG period is four, last four CG transmission occasions within a CG periodicity are reallocated by the RAN node, and cannot be used for transmission of the other two data packets. This undoubtedly increases a transmission delay of the data packets.

Method 3: The terminal obtains first configuration information used to configure a reporting periodicity of first indication information, and sends the first indication information on at least one CG transmission occasion within the CG period based on the reporting periodicity. Correspondingly, the first indication information indicates a CG transmission occasion that is unused within the CG period or a CG transmission occasion that is used within the CG period. Optionally, the first indication information is carried in UCI.

In the method 3, the terminal may report the CG transmission occasion that is unused within the CG period or the CG transmission occasion that is used within the CG period to the RAN node based on the obtained reporting periodicity, to flexibly determine an occasion for reporting the CG transmission occasion that is unused within the CG period or the CG transmission occasion that is used within the CG period, thereby saving resources. For example, the RAN node may allocate the unused CG transmission occasion to another service of the terminal or another terminal in a timely manner. In addition, in comparison with the method 1, the terminal does not need to report, on each CG transmission occasion within the CG period, the CG transmission occasion that is unused within the CG period, and repeated reporting for a plurality of times does not occur. In response to the first indication information being carried in the UCI, a quantity of UCI whose transmission is performed within the CG period can also be reduced, thereby reducing resources occupied by a code block corresponding to the UCI, and reducing complexity of the RAN node. In comparison with the method 2, the terminal does not fixedly report the CG transmission occasion that is unused within the CG period on the 1^{st} CG transmission occasion within the CG period, so that a case in which the reported unused CG transmission occasion is inaccurate can be avoided, and a transmission delay of a data packet can be further reduced.

A specific process of the foregoing method 3 is described in the following method shown in FIG. 4, and details are not described herein.

The following describes at least one embodiment in detail with reference to the accompanying drawings.

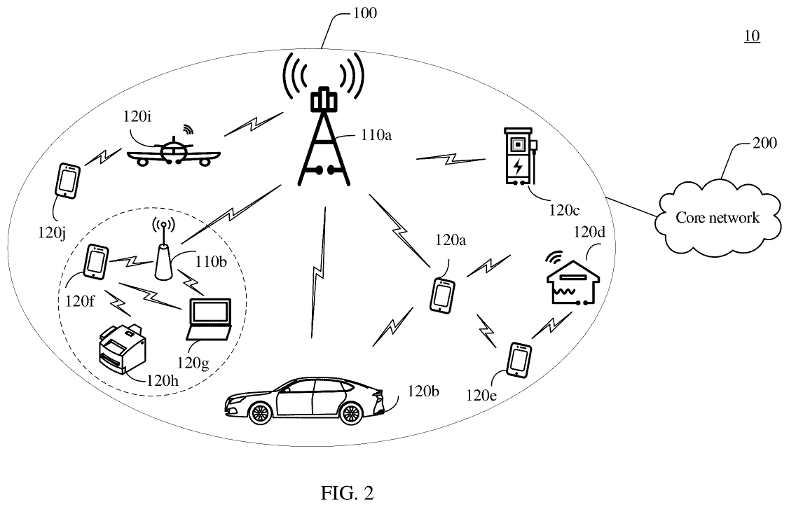

The methods provided in at least one embodiment may be used in various communication systems. The following uses a communication system 10 shown in FIG. 2 as an example to describe the methods provided in at least one embodiment. FIG. 2 is merely a diagram, and does not constitute a limitation on an applicable scenario of the technical solutions provided in at least one embodiment.

FIG. 2 is a diagram of at least one embodiment and non-limitative system. As shown in FIG. 2, a communication system 10 includes a RAN 100 and a core network (core network, CN) 200. The RAN 100 includes at least one RAN node (for example, 110a and 110b in FIG. 2, which are collectively referred to as 110) and at least one terminal (for example, 120a to 120j in FIG. 2, which are collectively referred to as 120). The RAN 100 may further include another RAN node, for example, a wireless relay device and/or a wireless backhaul device (not shown in FIG. 2). The terminal 120 is connected to the RAN node 110 in a wireless manner. The RAN node 110 is connected to the core network 200 in a wireless or wired manner. A core network device in the core network 200 and the RAN node 110 in the RAN 100 may be different physical devices, or may be a same physical device that integrates a logical function of the core network and a logical function of the radio access network.

The RAN 100 may be a cellular system related to a 3^{rd} generation partnership project (3^{rd} generation partnership project, 3GPP), for example, a 4G or 5G mobile communication system, or a future-oriented evolved system (for example, a 6G mobile communication system). Alternatively, the RAN 100 may be an open radio access network (open RAN, O-RAN or ORAN), a cloud radio access network (cloud radio access network, CRAN), or a wireless fidelity (wireless fidelity, Wi-Fi) system. Alternatively, the RAN 100 may be a communication system that integrates the foregoing two or more systems.

Alternatively, the RAN node 110 may be sometimes referred to as an access network device, a RAN entity, an access node, or the like, and forms a part of a communication system, to help a terminal implement radio access. A plurality of RAN nodes 110 in the communication system 10 may be nodes of a same type, or may be nodes of different types. In some scenarios, roles of the RAN node 110 and the terminal 120 are relative. For example, a network element 120i in FIG. 2 may be a helicopter or an uncrewed aerial vehicle, and may be configured as a mobile base station. For the terminal 120j that accesses the RAN 100 through the network element 120i, the network element 120i is a base station. However, for the base station 110a, the network element 120i is a terminal. Both the RAN node 110 and the terminal 120 are sometimes referred to as communication apparatuses. For example, network elements 110a and 110b in FIG. 2 may be understood as communication apparatuses having a base station function, and network elements 120a to 120j may be understood as communication apparatuses having a terminal function.

In at least one embodiment, the RAN node may be a base station (base station), an evolved NodeB (evolved NodeB, eNodeB), an access point (access point, AP), a transmission reception point (transmission reception point, TRP), a next generation NodeB (next generation NodeB, gNB), a next generation base station in a 6th generation (6th generation, 6G) mobile communication system, a base station in a future mobile communication system, an access node in a Wi-Fi system, or the like. The RAN node may be a macro base station (for example, 110a in FIG. 2), a micro base station or an indoor station (for example, 110b in FIG. 2), a relay node or a donor node, or a radio controller in a CRAN scenario. Optionally, the RAN node may alternatively be a server, a wearable device, a vehicle, a vehicle-mounted device, or the like. For example, an access network device in a vehicle-to-everything (vehicle-to-everything, V2X) technology may be a roadside unit (roadside unit, RSU). All or some functions of the RAN node in at least one embodiment may alternatively be implemented by using a software function running on hardware, or may be implemented by using an instantiated virtualization function on a platform (for example, a cloud platform). The RAN node in at least one embodiment may alternatively be a logical node, a logical module, or software that can implement all or some functions of the RAN node.

In at least one embodiment, a plurality of RAN nodes coordinate to assist the terminal in implementing radio access, and different RAN nodes separately implement some functions of the base station. For example, the RAN node may be a central unit (central unit, CU), a DU, a CU-control plane (control plane, CP), a CU-user plane (user plane, UP), or an RU. The CU and the DU may be separately disposed, or may be included in a same network element, for example, a baseband unit (baseband unit, BBU). The RU may be included in a radio frequency device or a radio frequency unit, for example, included in a remote radio unit (remote radio unit, RRU), an active antenna unit (active antenna unit, AAU), or a remote radio head (remote radio head, RRH).

In different systems, the CU (or the CU-CP and the CU-UP), the DU, or the RU may also have a different name, but a person skilled in the art may understand a meaning of the name. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as an example for description in at least one embodiment. Any one of the CU (or the CU-CP or the CU-UP), the DU, and the RU in at least one embodiment may be implemented by using a software module, a hardware module, or a combination of a software module and a hardware module.

The terminal may also be referred to as a terminal device, user equipment (user equipment, UE), a mobile station, a mobile terminal, or the like. The terminal may be widely used in various scenarios, for example, device-to-device (device-to-device, D2D), vehicle-to-everything (vehicle-to-everything, V2X) communication, machine-type communication (machine-type communication, MTC), internet of things (internet of things, IOT), virtual reality, augmented reality, industrial control, automatic driving, telemedicine, a smart grid, smart furniture, a smart office, smart wearable, smart transportation, and a smart city. The terminal may be a mobile phone, a tablet computer, a computer with a wireless transceiver function, a wearable device, a vehicle, an uncrewed aerial vehicle, a helicopter, an airplane, a ship, a robot, a robot arm, a smart home device, or the like. A device form of the terminal is not limited in embodiments described herein.

The terminal may alternatively be a VR terminal, an AR terminal, or a mixed reality (mixed reality, MR) terminal. The VR terminal, the AR terminal, and the MR terminal may all be referred to as extended reality (extended reality, XR) terminals. The XR terminal may be, for example, a head-mounted device (for example, a helmet, a head-mounted display (head-mounted display, HMD), or glasses), may be an all-in-one device, or may be a television, a display, a car, a vehicle-mounted device, a tablet, or a smart screen. The XR terminal may access a network in a wireless or wired manner, for example, access the network through a Wi-Fi or 5G system. The XR terminal can present XR data to a user, and the user can experience diversified XR services by wearing or using the XR terminal.

The communication system 10 shown in FIG. 2 is merely used as an example, but is not intended to limit the technical solutions of at least one embodiment. A person skilled in the art should understand that, in a specific implementation process, the communication system 10 may further include another device, and a quantity of RAN nodes and a quantity of terminals may alternatively be determined based on a specific requirement. This is not limited.

Optionally, each network element or device (for example, the RAN node or the terminal) in FIG. 2 in at least one embodiment may also be referred to as a communication apparatus, and may be a general-purpose device or a dedicated device. This is not specifically limited in at least one embodiment.

Optionally, related functions of each network element or device (for example, the RAN node or the terminal) in FIG. 2 in at least one embodiment may be implemented by one device, or may be jointly implemented by a plurality of devices, or may be implemented by one or more functional modules in one device. This is not specifically limited in at least one embodiment. It may be understood that, the foregoing function may be a network element in a hardware device, or may be a software function running on dedicated hardware, or a combination of hardware and software, or an instantiated virtualization function on a platform (for example, a cloud platform).

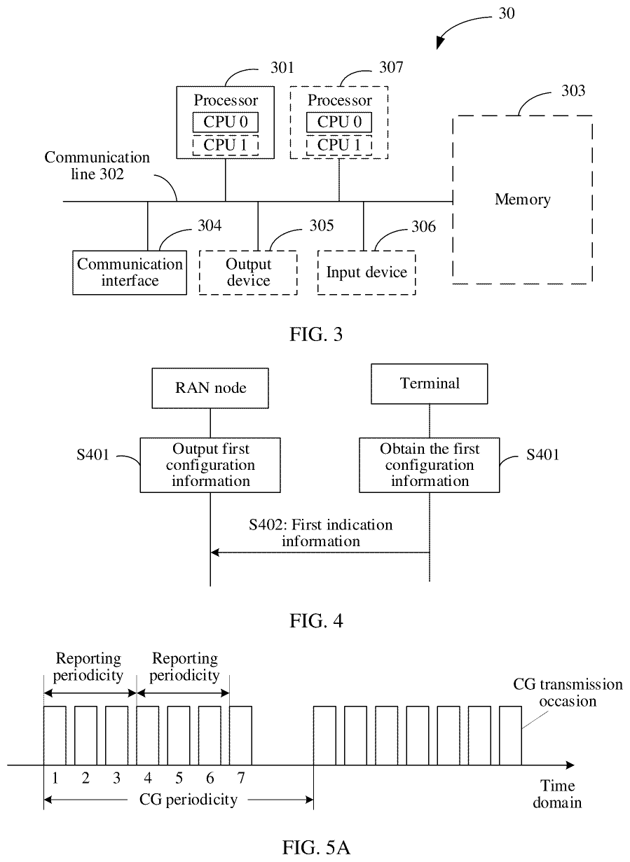

In a specific implementation, each network element or device (for example, the RAN node or the terminal) in FIG. 2 in at least one embodiment may use a composition structure shown in FIG. 3, or include components shown in FIG. 3. FIG. 3 is a diagram of a hardware structure of a communication apparatus applicable to at least one embodiment. The communication apparatus 30 includes at least one processor 301 and at least one communication interface 304, and is configured to implement the methods provided in at least one embodiment. The communication apparatus 30 may further include a communication line 302 and a memory 303.

The processor 301 may be a general-purpose central processing unit (central processing unit, CPU), a microprocessor, an application-specific integrated circuit (application-specific integrated circuit, ASIC), or one or more integrated circuits configured to control program execution of the solutions of at least one embodiment.

The communication line 302 may include a path, for example, a bus, for information transmission between the foregoing components.

The communication interface 304 is configured to communicate with another device or a communication network. The communication interface 304 may be any apparatus such as a transceiver, for example, may be an Ethernet interface, a radio access network (radio access network, RAN) interface, a wireless local area network (wireless local area network, WLAN) interface, a transceiver, a pin, a bus, or a transceiver circuit.

The memory 303 may be a read-only memory (read-only memory, ROM) or another type of static storage device that can store static information and instructions, or a random access memory (random access memory, RAM) or another type of dynamic storage device that can store information and instructions; or may be an electrically erasable programmable read-only memory (electrically erasable programmable read-only memory, EEPROM), a compact disc read-only memory (compact disc read-only memory, CD-ROM) or another compact disc storage, an optical disc storage (including a compact disc, a laser disc, an optical disc, a digital versatile disc, a Blu-ray disc, or the like), a magnetic disk storage medium or another magnetic storage device, or any other medium that can be configured to carry or store expected program code in a form of an instruction or a data structure and that can be accessible by a computer, but is not limited thereto. The memory may exist independently, and is coupled to the processor 301 through the communication line 302. Alternatively, the memory 303 may be integrated with the processor 301. The memory provided in at least one embodiment may be usually non-volatile.

The memory 303 is configured to store computer-executable instructions for executing the solutions provided in at least one embodiment, and the processor 301 controls execution. The processor 301 is configured to execute the computer-executable instructions stored in the memory 303, to implement the methods provided in at least one embodiment. Alternatively, optionally, in at least one embodiment, the processor 301 may perform functions related to processing in a method provided in the following embodiments, and the communication interface 304 is responsible for communication with another device or a communication network. This is not specifically limited in embodiments described herein.

Optionally, the computer-executable instructions in at least one embodiment may also be referred to as application program code. This is not specifically limited in embodiments described herein.

The coupling in at least one embodiment may be an indirect coupling or a communication connection between apparatuses, units, or modules in an electrical form, a mechanical form, or another form, and is used for information exchange between the apparatuses, the units, or the modules.

In an embodiment, the processor 301 may include one or more CPUs, for example, a CPU 0 and a CPU 1 in FIG. 3.

In an embodiment, the communication apparatus 30 may include a plurality of processors, for example, the processor 301 and a processor 307 in FIG. 3. Each of the processors may be a single-core (single-CPU) processor, or may be a multi-core (multi-CPU) processor. The processor herein may be one or more devices, circuits, and/or processing cores configured to process data (for example, computer program instructions).

In an embodiment, the communication apparatus 30 may further include an output device 305 and/or an input device 306. The output device 305 is coupled to the processor 301, and may display information in a plurality of manners. For example, the output device 305 may be a liquid crystal display (liquid crystal display, LCD), a light emitting diode (light emitting diode, LED) display device, a cathode ray tube (cathode ray tube, CRT) display device, or a projector (projector). The input device 306 is coupled to the processor 301, and may receive a user input in a plurality of manners. For example, the input device 306 may be a mouse, a keyboard, a touchscreen device, or a sensor device.

The composition structure shown in FIG. 3 does not constitute a limitation on the communication apparatus. In addition to the components shown in FIG. 3, the communication apparatus may include more or fewer components than those shown in the figure, or combine some components, or have a different component arrangement.

The following describes the method provided in at least one embodiment with reference to the accompanying drawings. Network elements in the following embodiments may have the components shown in FIG. 3, and details are not described again.

Names of messages between the network elements, names of parameters in the messages, or the like in the following embodiments are merely examples, and there may be other names in a specific implementation. This is not specifically limited in embodiments described herein.

In embodiments described herein, “/” may represent an “or” relationship between associated objects. For example, A/B may represent A or B. “And/or” may be used to describe three relationships existing between the associated objects. For example, “A and/or B” may represent the following three cases: Only A exists, both A and B exist, and only B exists, where A and B may be singular or plural. In addition, a representation similar to “at least one of A, B, and C” or “at least one of A, B, or C” is usually used to represent any one of the following: Only A exists; only B exists; only C exists; both A and B exist; both A and C exist; both B and C exist; and A, B, and C all exist. The foregoing uses a total of three elements A, B, and C as an example to describe an optional item of the project. In response to there being more elements in the representation, a meaning of the representation may be obtained according to the foregoing rules.

For ease of description of the technical solutions of at least one embodiment, in at least one embodiment, terms such as “first” and “second” may be used to distinguish between technical features with same or similar functions. The terms such as “first” and “second” do not limit a quantity and an execution sequence, and the terms such as “first” and “second” do not indicate a definite difference. In at least one embodiment, a term like “example” or “for example” is used to represent an example, evidence, or a description. Any embodiment or design solution described as an “example” or “for example” should not be explained as being more preferred or having more advantages than another embodiment or design solution. The term such as “example” or “for example” is used to present a related concept in a specific manner for ease of understanding.

Embodiment” mentioned throughout this specification means that particular features, structures, or characteristics related to this embodiment are included in at least one embodiment. Therefore, embodiments in this entire specification do not necessarily refer to a same embodiment. In addition, these particular features, structures, or characteristics may be combined in one or more embodiments in any proper manner. Sequence numbers of the processes do not mean execution sequences in at least one embodiment. The execution sequences of the processes should be determined based on functions and internal logic of the processes, and should not be construed as any limitation on implementation processes of at least one embodiment.

In at least one embodiment, “when” and “if” mean that corresponding processing is performed in an objective situation, are not intended to limit time, do not require a necessary determining action in an implementation, and do not mean any other limitation.

“Simultaneously” in at least one embodiment may be understood as being at a same time point, may be understood as being within a time period, or may be understood as being within a same periodicity.

In some scenarios, some optional features in at least one embodiment may be independently implemented without depending on another feature, for example, a solution on which the optional features are currently based, to resolve a corresponding technical problem and achieve corresponding effects. Alternatively, in some scenarios, the optional features may be combined with another feature based on a requirement. Correspondingly, the apparatus provided in at least one embodiment may also correspondingly implement these features or functions. Details are not described herein.

A same step or steps or technical features that have a same function in at least one embodiment may be mutually referenced in different embodiments.

In at least one embodiment, a RAN node and/or a terminal may perform some or all steps in at least one embodiment. These steps are merely examples. In at least one embodiment, other steps or variations of various steps may alternatively be performed. In addition, the steps may be performed in a sequence different from a sequence presented in at least one embodiment, and not all the steps in at least one embodiment may be necessarily performed.

The “sending information (for example, first configuration information) to the terminal” in at least one embodiment may be understood as that a destination end of the information is the terminal, and may include directly or indirectly sending the information to the terminal. “Receiving information (for example, first indication information) from the terminal” may be understood as that a source end of the information is the terminal, and may include directly or indirectly receiving the information from the terminal. Information may undergo necessary processing between the source end for sending the information and the destination end, for example, a format change. However, the destination end may understand valid information from the source end. Similar descriptions in at least one embodiment may be understood similarly, and details are not described herein again.

The “sending information (for example, first indication information) to the RAN node” in at least one embodiment may be understood as that a destination end of the information is the RAN node, and may include directly or indirectly sending the information to the RAN node. “Receiving information (for example, first configuration information) from the RAN node” may be understood as that a source end of the information is the RAN node, and may include directly or indirectly receiving the information from the RAN node. Information may undergo necessary processing between the source end for sending the information and the destination end, for example, a format change. However, the destination end may understand valid information from the source end. Similar descriptions in at least one embodiment may be understood similarly, and details are not described herein again.

In the method provided below in at least one embodiment, the method is illustrated by using an example in which the RAN node and the terminal are used as execution bodies of interaction illustration. However, the execution bodies of the interaction illustration are not limited in embodiments described herein. For example, the RAN node in the method provided in at least one embodiment may be a chip, a chip system, or a processor that supports the RAN node in implementing the method, or may be a logical node, a logical module, or software that can implement all or some functions of the RAN node. Alternatively, the terminal in the method provided in at least one embodiment may be a chip, a chip system, or a processor that supports the terminal in implementing the method, or may be a logical node, a logical module, or software that can implement all or some functions of the terminal.

FIG. 4 shows an information transmission method according to at least one embodiment. The method may include the following steps.

S401: ARAN node outputs first configuration information. Correspondingly, a terminal obtains the first configuration information.

The RAN node may be the RAN node 110, and the terminal may be the terminal 120.

In at least one embodiment, that the RAN node outputs the first configuration information may be understood as that the RAN node sends the first configuration information to another apparatus. For example, the RAN node sends the first configuration information to the terminal. Alternatively, that the RAN node outputs the first configuration information may be understood as that a RAN node implementing some functions of a base station outputs the first configuration information to another RAN node implementing some functions of the base station. For example, a DU outputs the first configuration information to an RU.

In at least one embodiment, that the terminal obtains the first configuration information may be understood as that the terminal receives the first configuration information from another apparatus. For example, the terminal receives the first configuration information from the RAN node. Alternatively, that the terminal obtains the first configuration information may be understood as that a module of the terminal obtains the first configuration information from another module of the terminal. For example, a baseband processing module of the terminal may restore a baseband signal from a radio frequency module, and then decode the baseband signal to obtain the first configuration information.

In at least one embodiment, the first configuration information may be used to configure a reporting periodicity of first indication information. In this way, the terminal may report the first indication information based on the reporting periodicity configured by the RAN node. Optionally, the first configuration information is carried in an RRC message. The first configuration information may not be used to configure the reporting periodicity. For example, the reporting periodicity is preset or pre-specified.

In at least one embodiment, the first indication information may indicate a CG transmission occasion that is unused within a CG period or a CG transmission occasion that is used within a CG period. The CG transmission occasion that is unused within the CG period may be understood as that the terminal does not send data or a PUSCH on the CG transmission occasion. The CG transmission occasion that is used within the CG period may be understood as that the terminal sends data or a PUSCH on the CG transmission occasion.

After the terminal reports the first indication information based on the reporting periodicity configured by the RAN node, the RAN node may determine, based on the first indication information, the CG transmission occasion that is unused within the CG period, and reallocate the unused CG transmission, thereby saving resources.

Optionally, the first indication information is carried in UCI. In other words, the UCI may be multiplexed on the CG transmission occasion within the CG period.

The reporting periodicity of the first indication information is less than a CG periodicity, or the reporting periodicity of the first indication information is less than or equal to the CG periodicity. In this way, the terminal may report the first indication information at least once within each CG period.

The RAN node may configure the reporting periodicity based on a value of the reporting periodicity of the first indication information. For example, the first configuration information includes the value of the reporting periodicity.

In at least one embodiment, the first configuration information includes N+1, that is, the reporting periodicity of the first indication information configured by the RAN node is N+1; or the first configuration information includes N, that is, the reporting periodicity of the first indication information configured by the RAN node is N. N represents a quantity of CG transmission occasions between two adjacent CG transmission occasions on which the first indication information is carried within the CG period, and Nis an integer greater than or equal to 0. N is less than a quantity of CG transmission occasions within the CG period.

In an example, in response to the CG period including seven CG transmission occasions, and N is equal to 2, the first configuration information includes 2 or 3, and a reporting periodicity of the first indication information may be shown in FIG. 5A. Within a 1^{st} CG periodicity in FIG. 5A, the terminal may report the first indication information on a CG transmission occasion 1, a CG transmission occasion 4, and a CG transmission occasion 7. There are two CG transmission occasions between the CG transmission occasion 4 and the CG transmission occasion 1, and there are two CG transmission occasions between the CG transmission occasion 7 and the CG transmission occasion 4.

In at least one embodiment, the first configuration information includes T, that is, the reporting periodicity of the first indication information configured by the RAN node is T. T represents a time difference between two adjacent CG transmission occasions on which the first indication information is carried within the CG period. Optionally, T is in a unit of slot (slot), ms, or the like, and T is greater than or equal to 0.

In an example, in response to the CG period including seven CG transmission occasions, and the first configuration information includes T, a reporting periodicity of the first indication information may be shown in FIG. 5B. Within a 1^{st} CG periodicity in FIG. 5B, the terminal may report the first indication information on a CG transmission occasion 1, a CG transmission occasion 3, a CG transmission occasion 5, and a CG transmission occasion 7. A time difference between the CG transmission occasion 3 and the CG transmission occasion 1 is T, a time difference between the CG transmission occasion 5 and the CG transmission occasion 3 is T, and a time difference between the CG transmission occasion 7 and the CG transmission occasion 5 is T.

In at least one embodiment, a time difference between any two CG transmission occasions (for example, a time difference between two adjacent CG transmission occasions on which the first indication information is carried win the CG period) may be understood as a time difference between a start time domain position of one CG transmission occasion and a start time domain position of another CG transmission occasion, or a time difference between an end time domain position of one CG transmission occasion and an end time domain position of another CG transmission occasion. Centralized descriptions are provided herein, and details are not described below.

In FIG. 5A, a time length of a 1^{st} reporting periodicity (for example, a time difference between a start time domain position of the CG transmission occasion 4 and a start time domain position of the CG transmission occasion 1) is the same as a time length of a 2^{nd} reporting periodicity (for example, a time difference between a start time domain position of the CG transmission occasion 7 and a start time domain position of the CG transmission occasion 4). However, in at least one embodiment, within one CG period, another uplink/downlink resource may be further included between two adjacent CG transmission occasions. In response to the two adjacent CG transmission occasions being considered as one CG transmission occasion group, quantities and sizes of uplink/downlink resources included between two CG transmission occasions in different CG transmission occasion groups may be different. Therefore, time differences between the two CG transmission occasions in the different CG transmission occasion groups may be different. To be specific, in at least one embodiment, a time difference between the CG transmission occasion 2 and the CG transmission occasion 1 in FIG. 5A may be different from a time difference between the CG transmission occasion 5 and the CG transmission occasion 4, a time difference between the CG transmission occasion 3 and the CG transmission occasion 2 may be different from a time difference between the CG transmission occasion 6 and the CG transmission occasion 5, and a time difference between the CG transmission occasion 4 and the CG transmission occasion 3 may be different from a time difference between the CG transmission occasion 7 and the CG transmission occasion 6. Therefore, in at least one embodiment, the time length of the 1^{st} reporting periodicity in FIG. 5A may be different from the time length of the 2^{nd} reporting periodicity. Based on a similar reason, in at least one embodiment, a quantity of CG transmission occasions included in a 1^{st} T, a quantity of CG transmission occasions included in a 2^{nd} T, and a quantity of CG transmission occasions included in a 3^{rd} T in FIG. 5B may be the same or may be different.

Optionally, the first configuration information is further used to configure a 1^{st} CG transmission occasion on which the first indication information is carried within the CG period. In this way, the terminal may determine a start CG transmission occasion on which the first indication information is carried within a CG periodicity. The first configuration information may not be used to configure the 1^{st} CG transmission occasion on which the first indication information is carried within the CG period, and the CG transmission occasion is preset or pre-specified.

In at least one embodiment, the RAN node configures the CG transmission occasion based on an index of the 1^{st} CG transmission occasion on which the first indication information is carried within the CG period. The index may indicate which CG transmission occasion within the CG period is the 1^{st} CG transmission occasion on which the first indication information is carried.

For example, the reporting periodicity of the first indication information shown in FIG. 5A is used as an example. In response to the first configuration information including 1, the 1^{st} CG transmission occasion on which the first indication information is carried within the CG period is the CG transmission occasion 1. Within the 1^{st} CG periodicity in FIG. 5A, the terminal may report the first indication information on the CG transmission occasion 1, the CG transmission occasion 4, and the CG transmission occasion 7.

For example, the reporting periodicity of the first indication information shown in FIG. 5B is used as an example, and in FIG. 5B, the quantity of CG transmission occasions included in the 1^{st} T, the quantity of CG transmission occasions included in the 2^{nd} T, and the quantity of CG transmission occasions included in the 3^{rd} T are the same. In response to the first configuration information including 2, the 1^{st} CG transmission occasion on which the first indication information is carried within the CG period is the CG transmission occasion 2. Within the 1^{st} CG periodicity in FIG. 5B, the terminal may report the first indication information on the CG transmission occasion 2, the CG transmission occasion 4, and the CG transmission occasion 6.

Optionally, the first configuration information is further used to configure a first threshold. The first threshold is a minimum interval between a CG transmission occasion on which the first indication information is carried within the CG period and a CG transmission occasion that is unused within the CG period. To be specific, an interval between the CG transmission occasion on which the first indication information is carried within the CG period and the CG transmission occasion that is unused within the CG period is greater than the first threshold, or an interval between the CG transmission occasion on which the first indication information is carried within the CG period and the CG transmission occasion within the CG period is greater than or equal to the first threshold. In this way, time may be reserved for the RAN node to reallocate the CG transmission occasion that is unused within the CG period. The first configuration information may not be used to configure the first threshold, and the first threshold is preset or pre-specified.

In an example, the first threshold is a time difference between a 1^{st} CG transmission occasion that is unused within the CG period and a CG transmission occasion on which the first indication information is carried within the CG period. Alternatively, the first threshold is a quantity of CG transmission occasions between the 1^{st} CG transmission occasion that is unused within the CG period and the CG transmission occasion on which the first indication information is carried within the CG period.

The RAN node may further configure a CG transmission occasion within the CG period.

In an example, the RAN node may configure the CG transmission occasion within the CG period by using S3.1 or S3a and S3b.

In another example, in S401, the first configuration information is used not only to configure the reporting periodicity of the first indication information, but also to configure the CG transmission occasion within the CG period.

S402: The terminal sends the first indication information to the RAN node on at least one CG transmission occasion within the CG period based on the reporting periodicity of the first indication information. Correspondingly, the RAN node receives the first indication information from the terminal on the at least one CG transmission occasion within the CG period based on the reporting periodicity of the first indication information.

The at least one CG transmission occasion in S402 is determined by the terminal based on the first configuration information. The at least one CG transmission occasion determined by the terminal varies with content configured based on the first configuration information.

In at least one embodiment, in response to the first configuration information being used to configure the reporting periodicity of the first indication information, the at least one CG transmission occasion includes a CG transmission occasion determined within the CG period based on the reporting periodicity.

In an example, in response to the CG period including seven CG transmission occasions, and the reporting periodicity N of the first indication information, configured based on the first configuration information, is equal to 2, the reporting periodicity of the first indication information may be shown in FIG. 5A. Within the 1^{st} CG periodicity in FIG. 5A, the at least one CG transmission occasion includes the CG transmission occasion 1, the CG transmission occasion 4, and the CG transmission occasion 7.

In at least one embodiment, in response to the first configuration information being used to configure the reporting periodicity of the first indication information and the 1^{st} CG transmission occasion on which the first indication information is carried within the CG period, the at least one CG transmission occasion includes a CG transmission occasion that is in CG transmission occasions having a periodicity of N and starting from the 1^{st} CG transmission occasion on which the first indication information is carried within the CG period.

In an example, in response to the CG period including seven CG transmission occasions, the reporting periodicity N of the first indication information, configured based on the first configuration information, is equal to 2, and the 1^{st} CG transmission occasion on which the first indication information is carried within the CG period is the CG transmission occasion 2, the reporting periodicity of the first indication information may be shown in FIG. 5A. Within the 1^{st} CG periodicity in FIG. 5A, the at least one CG transmission occasion includes the CG transmission occasion 2 and the CG transmission occasion 5. The CG transmission occasion 2 is a start CG transmission occasion on which the first indication information is carried within the CG period configured based on the first configuration information, and the CG transmission occasion 5 is determined based on N.

In at least one embodiment, in response to the first configuration information being used to configure the reporting periodicity of the first indication information and the first threshold, the at least one CG transmission occasion includes a CG transmission occasion that is in CG transmission occasions determined based on the reporting periodicity within the CG period and that has an interval, greater than or equal to the first threshold, from the CG transmission occasion unused within the CG period.

In an example, in response to the CG period including seven CG transmission occasions, the reporting periodicity N of the first indication information, configured based on the first configuration information, is equal to 2, and the first threshold is equal to 2 (that is, two CG transmission occasions), the reporting periodicity of the first indication information may be shown in FIG. 5A. In response to the first threshold not being considered, the at least one CG transmission occasion includes the CG transmission occasion 1, the CG transmission occasion 4, and the CG transmission occasion 7. In response to the first threshold being considered, in response to the CG transmission occasion that is unused within the CG period being the CG transmission occasion 7, because an interval between the CG transmission occasion 7 and the CG transmission occasion 1 is greater than the first threshold, an interval between the CG transmission occasion 7 and the CG transmission occasion 4 is equal to the first threshold, and no data transmission is performed on the CG transmission occasion 7, the at least one CG transmission occasion includes the CG transmission occasion 1 and the CG transmission occasion 4.

In at least one embodiment, in response to the first configuration information being used to configure the reporting periodicity of the first indication information, the 1^{st} CG transmission occasion on which the first indication information is carried within the CG period, and the first threshold, the at least one CG transmission occasion includes a CG transmission occasion that is in CG transmission occasions having a periodicity of N and starting from the 1^{st} CG transmission occasion on which the first indication information is carried within the CG period and that has an interval, greater than or equal to the first threshold, from the CG transmission occasion unused within the CG period.

In another example, in response to the CG period including seven CG transmission occasions, the reporting periodicity N of the first indication information, configured based on the first configuration information, is equal to 2, the 1^{st} CG transmission occasion on which the first indication information is carried within the CG period is the CG transmission occasion 2, and the first threshold is equal to 2 (that is, two CG transmission occasions), the reporting periodicity of the first indication information may be shown in FIG. 5A. In response to the first threshold not being considered, the at least one CG transmission occasion includes the CG transmission occasion 2 and the CG transmission occasion 5. In response to the first threshold being considered, in response to CG transmission occasions that are unused within the CG period being the CG transmission occasion 6 and the CG transmission occasion 7, because an interval between the CG transmission occasion 6 and the CG transmission occasion 2 is greater than the first threshold, and an interval between the CG transmission occasion 6 and the CG transmission occasion 5 is less than the first threshold, the at least one CG transmission occasion includes the CG transmission occasion 2.

The actions of the RAN node or the terminal in S401 and S402 may be performed by the processor 301 in the communication apparatus 30 shown in FIG. 3 by invoking the application program code stored in the memory 303. This is not limited in embodiments described herein.

According to the method shown in FIG. 4, the RAN node may configure the reporting periodicity of the first indication information for the terminal, and the terminal may report the first indication information based on the reporting periodicity. In this way, the RAN node may determine, based on the first indication information, the CG transmission occasion that is unused within the CG period, thereby saving resources. For example, the RAN node may reallocate the unused CG transmission occasion, for example, allocate, in a CS manner, the unused CG transmission occasion to another service of the terminal, or allocate the unused CG transmission occasion to another terminal other than this terminal. In addition, in comparison with the foregoing method 1, the terminal does not need to report, on each CG transmission occasion within the CG period, the CG transmission occasion that is unused within the CG period, and repeated reporting for a plurality of times does not occur. In response to the first indication information being carried in the UCI, a quantity of UCI whose transmission is performed within the CG period can also be reduced, thereby reducing resources occupied by a code block corresponding to the UCI, and reducing complexity of the RAN node. In comparison with the foregoing method 2, the terminal does not fixedly report the CG transmission occasion that is unused within the CG period on the 1^{st} CG transmission occasion within the CG period, so that a case in which the reported unused CG transmission occasion is inaccurate can be avoided, and a transmission delay of a data packet can be further reduced.

Optionally, the terminal may determine a quantity of CG transmission occasions that are unused within the CG period or a quantity of CG transmission occasions that are used within the CG period, and determine, based on the quantity, a CG transmission occasion that is unused within the CG period or a CG transmission occasion that is used within the CG period.

In at least one embodiment, the terminal may determine the quantity of CG transmission occasions that are unused within the CG period or the quantity of CG transmission occasions that are used within the CG period in either of the following two manners.

Manner A: The quantity of CG transmission occasions that are unused within the CG period or the quantity of CG transmission occasions that are used within the CG period is related to a buffer state of the terminal.

In an example, the quantity of CG transmission occasions that are unused within the CG period satisfies the following formula: R₁=R−ceil[W/S]. R₁ represents the quantity of CG transmission occasions that are unused within the CG period, R represents the quantity of remaining available CG transmission occasions within the CG period or the quantity of CG transmission occasions that are not used within the CG period, W represents a buffer state value (buffer state value) of the terminal, S represents an amount of data whose transmission can be performed on the CG transmission occasions, and ceil[ ] represents rounding up. The quantity R₂ of CG transmission occasions that are used within the CG period satisfies the following formula: R₂=ceil[W/S].

Manner B: The quantity of CG transmission occasions that are unused within the CG period or the quantity of CG transmission occasions that are used within the CG period is related to a size of to-be-sent data (for example, a size of a protocol data unit (protocol data unit, PDU) set (PDU set) or a size of a video frame) within the CG period.

In an example, the quantity of CG transmission occasions that are unused within the CG period satisfies the following formula: R₁=P−ceil[Q/S]. R₁ represents the quantity of CG transmission occasions that are unused within the CG period, P represents a quantity of CG transmission occasions within the CG period, Q represents a size of to-be-sent data within the CG period, and S represents an amount of data whose transmission can be performed on the CG transmission occasions. The quantity R₂ of CG transmission occasions that are used within the CG period satisfies the following formula: R₂=ceil[Q/S].

After determining the quantity of CG transmission occasions that are unused within the CG period or the quantity of CG transmission occasions that are used within the CG period, the terminal may determine which CG transmission occasion within the CG period is an unused CG transmission occasion and which CG transmission occasion within the CG period is a used CG transmission occasion.

For example, in response to the terminal determines that the quantity of CG transmission occasions that are unused within the CG period being R₁, the terminal may determine that last R₁ CG transmission occasions within the CG period are unused CG transmission occasions, and a CG transmission occasion preceding the R₁ CG transmission occasions within the CG period is a used CG transmission occasion. For example, in response to the CG period including eight CG transmission occasions, and R₁ is equal to 3, the terminal determines that last three CG transmission occasions within the CG period are unused CG transmission occasions, and first five CG transmission occasions within the CG period are used CG transmission occasions.

For example, in response to the terminal determining that the quantity of CG transmission occasions that are used within the CG period is R₂, the terminal may determine that first R₂ CG transmission occasions within the CG period are used CG transmission occasions, and that a CG transmission occasion following the R₂ CG transmission occasions within the CG period is an unused CG transmission occasion. For example, in response to the CG period including eight CG transmission occasions, and R₂ is equal to 4, the terminal determines that first four CG transmission occasions within the CG period are used CG transmission occasions, and last four CG transmission occasions within the CG period are unused CG transmission occasions.

Optionally, in at least one embodiment of the method shown in FIG. 4, the terminal may indicate, based on the quantity of CG transmission occasions that are unused within the CG period, the CG transmission occasions that are unused within the CG period. For example, the first indication information includes the quantity R₁ of CG transmission occasions that are unused within the CG period. In this way, the RAN node may determine, based on the first indication information, that the last R₁ CG transmission occasions within the CG period are unused.

Optionally, in response to the terminal indicating, based on the quantity of CG transmission occasions that are unused within the CG period, the CG transmission occasions that are unused within the CG period, within the CG period, a quantity of unused CG transmission occasions indicated by the first indication information sent earlier is less than a quantity of unused CG transmission occasions indicated by the first indication information sent later; or a quantity of unused CG transmission occasions indicated by the first indication information sent earlier is less than or equal to a quantity of unused CG transmission occasions indicated by the first indication information sent later. In this way, after the RAN node reallocates the unused CG transmission occasions, the terminal is able to avoid indicating that these CG transmission occasions are to be used, leading to related interference between terminals.

For example, the at least one CG transmission occasion includes a first CG transmission occasion and a second CG transmission occasion, and the first CG transmission occasion precedes the second CG transmission occasion. In response to the quantity of unused CG transmission occasions indicated by the first indication information carried on the first CG transmission occasion being M1, and the quantity of unused CG transmission occasions indicated by the first indication information carried on the second CG transmission occasion is M2, M1 is less than M2, or M1 is less than or equal to M2.

Optionally, in at least one embodiment of the method shown in FIG. 4, the terminal may indicate, based on the quantity of CG transmission occasions that are used within the CG period, CG transmission occasions that are unused within the CG period. For example, the first indication information includes the quantity R₂ of CG transmission occasions that are used within the CG period. In this way, the RAN node may determine, based on the first indication information, that last (P−R₂) CG transmission occasions within the CG period are unused.

Optionally, in response to the terminal indicating, based on the quantity of CG transmission occasions that are used within the CG period, CG transmission occasions that are unused within the CG period, within the CG period, a quantity of used CG transmission occasions indicated by the first indication information sent earlier is greater than a quantity of used CG transmission occasions indicated by the first indication information sent later; or a quantity of used CG transmission occasions indicated by the first indication information sent earlier is greater than or equal to a quantity of used CG transmission occasions indicated by the first indication information sent later. In this way, after the RAN node reallocates the unused CG transmission occasions, the terminal is able to avoid indicating that these CG transmission occasions are to be used, leading to related interference between terminals.

For example, the at least one CG transmission occasion includes a first CG transmission occasion and a second CG transmission occasion, and the first CG transmission occasion precedes the second CG transmission occasion. In response to the quantity of used CG transmission occasions indicated by the first indication information carried on the first CG transmission occasion being M3, and the quantity of used CG transmission occasions indicated by the first indication information carried on the second CG transmission occasion is M4, M3 is greater than M4, or M3 is greater than or equal to M4.

Optionally, in at least one embodiment of the method shown in FIG. 4, a CG transmission occasion that is unused within the CG period or a CG transmission occasion that is used within the CG period indicated by the first indication information is related to the first interval. The first interval is an interval between a CG transmission occasion that is unused within the CG period and a CG transmission occasion on which the first indication information (for example, a quantity of CG transmission occasions or a time difference between the CG transmission occasion that is unused within the CG period and the CG transmission occasion on which the first indication information is carried) is carried, or the first interval is an interval between a CG transmission occasion that is used within the CG period and a CG transmission occasion on which the first indication information (for example, a quantity of CG transmission occasions or a time difference between the CG transmission occasion that is used within the CG period and the CG transmission occasion on which the first indication information is carried) is carried. The time difference is in a unit of slot or ms.

For example, in response to the at least one CG transmission occasion including a third CG transmission occasion, the first indication information carried on the third CG transmission occasion may indicate whether a fourth CG transmission occasion following the third CG transmission occasion is used. To be specific, the first indication information carried on the third CG transmission occasion may indicate that a CG transmission occasion that is unused within the CG period includes the fourth transmission occasion, or the first indication information carried on the third CG transmission occasion may indicate that a CG transmission occasion that is used within the CG period includes the fourth transmission occasion. There is the first interval between the third CG transmission occasion and the fourth CG transmission occasion.

In an example, the first indication information carried on the third CG transmission occasion includes one bit. In response to a value of the one bit being “0”, the first indication information indicates that the fourth CG transmission occasion is unused; in response to the value of the one bit being “1”, the first indication information indicates that the fourth CG transmission occasion is used; and vice versa.

In the foregoing example, regardless of whether the fourth CG transmission occasion is used, the terminal sends the first indication information on the third CG transmission occasion. In at least one embodiment, the terminal may alternatively send the first indication information on the third CG transmission occasion in response to determining that the fourth CG transmission occasion being unused, and does not send the first indication information on the third CG transmission occasion in response to determining that the fourth CG transmission occasion being used. This is not limited.

Optionally, the CG transmission occasions that are unused within the CG period further include a CG transmission occasion following the fourth CG transmission occasion within the CG period. In other words, the CG transmission occasion following the fourth CG transmission occasion within the CG period is unused.

In response to a CG transmission occasion that is unused within the CG period or a CG transmission occasion that is used within the CG period indicated by the first indication information being related to the first interval, the first configuration information is further used to configure the first interval.

The first configuration information may not be used to configure the first interval, and the first interval is preset or pre-specified.

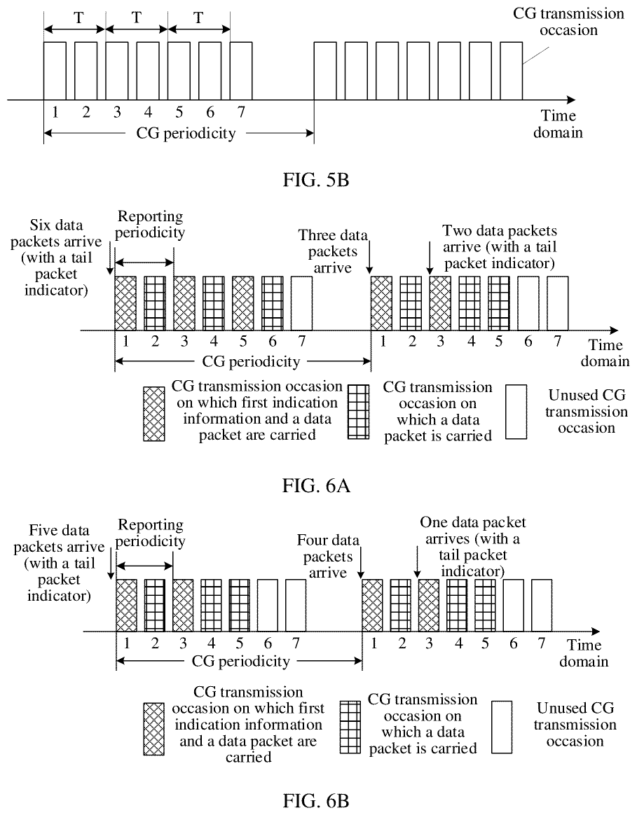

For better understanding of the method provided in at least one embodiment, a specific process of the information transmission method provided in at least one embodiment is described below with reference to FIG. 6A and FIG. 6B. In the following examples, one CG transmission occasion can be used for transmission of one data packet.

Refer to FIG. 6A. A RAN node configures seven CG transmission periodicities within a CG periodicity for a terminal based on first configuration information (FIG. 6A shows CG transmission occasions within two CG periodicities), a reporting periodicity N of first indication information is equal to 1, and a first threshold is one CG transmission occasion. The following describes reporting of the first indication information within a 1^{st} CG periodicity and a 2^{nd} CG periodicity separately.

In response to the terminal receiving six data packets before a CG transmission occasion 1 within the 1^{st} CG periodicity, and receives a tail packet indicator (where the tail packet indicator is carried in a last data packet and indicates that the data packet is the last data packet), the terminal determines, based on the foregoing manner A or manner B, that a quantity of CG transmission occasions that are unused within a 1^{st} CG periodicity is 1, that is, the unused CG transmission occasion is a CG transmission occasion 7. The terminal sends the data packets on the CG transmission occasion 1 to a CG transmission occasion 6 within the 1^{st} CG period. Because the first configuration information is used to configure that the first indication information is reported once every other CG transmission occasion, the CG transmission occasion 7 is unused, an interval between the CG transmission occasion 7 and the CG transmission occasion 1 is greater than the first threshold, an interval between the CG transmission occasion 7 and a CG transmission occasion 3 is greater than the first threshold, and an interval between the CG transmission occasion 7 and a CG transmission occasion 5 is equal to the first threshold, the terminal reports the first indication information on the CG transmission occasion 1, the CG transmission occasion 3, and the CG transmission occasion 5. The first indication information indicates that the quantity of CG transmission occasions that are unused within the CG period is 1. After receiving the first indication information, the RAN node determines that the CG transmission occasion 7 within the 1^{st} CG period is unused.

The terminal receives three data packets before the CG transmission occasion 1 within the 2^{nd} CG periodicity, but does not receive the tail packet indicator. In other words, the terminal has not received the last data packet, and the terminal receives two data packets and receives the tail packet indicator on the CG transmission occasion 3. Therefore, the terminal sends the data packets on the CG transmission occasion 1 to the CG transmission occasion 5. In response to not being In response to not being specified that within the CG period, a quantity of unused CG transmission occasions indicated by the first indication information sent earlier is less than or equal to a quantity of unused CG transmission occasions indicated by the first indication information sent later, the terminal determines, on the CG transmission occasion 1 within the 2^{nd} CG periodicity, that the quantity of CG transmission occasions that are unused within a 2^{nd} CG period is 4. Therefore, the terminal reports the first indication information on the CG transmission occasion 1, and the first indication information indicates that the quantity of unused CG transmission occasions is 4. The RAN node may determine, based on the first indication information, that a CG transmission occasion 4 to the CG transmission occasion 7 are unused. The terminal determines, on the CG transmission occasion 3 within the 2^{nd} CG periodicity based on the foregoing manner A or manner B, that the quantity of CG transmission occasions that are unused within the 2^{nd} CG period is 2. Therefore, the terminal reports the first indication information on the CG transmission occasion 3, and the first indication information indicates that the quantity of CG transmission occasions that are unused is 2. The RAN node may determine, based on the first indication information, that the CG transmission occasion 6 and the CG transmission occasion 7 are unused. In response to the RAN node having reallocated the CG transmission occasion 4 and the CG transmission occasion 5, the terminal cannot send the data packets on the CG transmission occasion 4 and the CG transmission occasion 5. Within the 2^{nd} CG periodicity, an interval between the CG transmission occasion 6 and the CG transmission occasion 5 is less than the first threshold. Therefore, the terminal does not report the first indication information on the CG transmission occasion 5. In response to In response to being specified that within the CG period, a quantity of unused CG transmission occasions indicated by the first indication information sent earlier is less than or equal to a quantity of unused CG transmission occasions indicated by the first indication information sent later, the terminal does not receive a tail packet indicator on the CG transmission occasion 1 within the 2^{nd} CG periodicity, and cannot determine the quantity of CG transmission occasions that are actually unused within the 2^{nd} CG period. Therefore, the terminal reports the first indication information on the CG transmission occasion 1, and the first indication information indicates that the quantity of unused CG transmission occasions is 0. The RAN node may determine, based on the first indication information, that there is no unused CG transmission occasion within the 2^{nd} CG period. The terminal determines, on the CG transmission occasion 3 within the 2^{nd} CG periodicity based on the foregoing manner A or manner B, that the quantity of CG transmission occasions that are unused within the 2^{nd} CG period is 2. Therefore, the terminal reports the first indication information on the CG transmission occasion 3, and the first indication information indicates that the quantity of CG transmission occasions that are unused is 2. The RAN node may determine, based on the first indication information, that the CG transmission occasion 6 and the CG transmission occasion 7 are unused. Within the 2^{nd} CG periodicity, an interval between the CG transmission occasion 6 and the CG transmission occasion 5 is less than the first threshold. Therefore, the terminal does not report the first indication information on the CG transmission occasion 5.

Refer to FIG. 6B. A RAN node configures seven CG transmission periodicities within a CG periodicity for a terminal based on first configuration information (FIG. 6B shows CG transmission occasions within two CG periodicities). A reporting periodicity N of first indication information is equal to 1, and a first interval between a CG transmission occasion that is unused within a CG period and a CG transmission occasion on which the first indication information is carried is two CG transmission occasions. The following describes reporting of the first indication information within a 1^{st} CG periodicity and a 2^{nd} CG periodicity separately.

In response to the terminal receiving five data packets before a CG transmission occasion 1 within the 1^{st} CG periodicity and receives a tail packet indicator, the terminal determines, based on the foregoing manner A or manner B, that a quantity of unused CG transmission occasions within a 1^{st} CG period is 2, that is, the unused CG transmission occasions are a CG transmission occasion 6 and a CG transmission occasion 7. The terminal sends the data packets on the CG transmission occasion 1 to a CG transmission occasion 5 within the 1^{st} CG period. Because the first configuration information is used to configure that the first indication information is reported once every other CG transmission occasion, the first configuration information is further used to configure that an interval between a CG transmission occasion that is unused within the CG period and a CG transmission occasion on which the first indication information is carried is two CG transmission occasions, and the CG transmission occasion 6 and the CG transmission occasion 7 are unused, the terminal reports the first indication information on the CG transmission occasion 1, and the first indication information indicates that the CG transmission occasion 4 is used. After receiving the first indication information, the RAN node determines that the terminal needs to use the CG transmission occasion 4. The terminal further reports the first indication information on the CG transmission occasion 3, and the first indication information indicates that the CG transmission occasion 6 is unused. After receiving the first indication information, the RAN node determines that the terminal does not use the CG transmission occasion 6, and the RAN node may further determine that the terminal does not use the CG transmission occasion 7 either.

The terminal receives four data packets before the CG transmission occasion 1 within the 2^{nd} CG periodicity, but does not receive the tail packet indicator. In other words, the terminal has not received a last data packet, and the terminal receives one data packet and receives the tail packet indicator on the CG transmission occasion 3. Therefore, the terminal sends the data packets on the CG transmission occasion 1 to the CG transmission occasion 5. Because the first configuration information is used to configure that the first indication information is reported once every other CG transmission occasion, the first configuration information is further used to configure that an interval between a CG transmission occasion that is unused within the CG period and a CG transmission occasion on which the first indication information is carried is two CG transmission occasions, and the CG transmission occasion 6 and the CG transmission occasion 7 are unused, the terminal reports the first indication information on the CG transmission occasion 1, and the first indication information indicates that the CG transmission occasion 4 is used. After receiving the first indication information, the RAN node determines that the terminal needs to use the CG transmission occasion 4. The terminal further reports the first indication information on the CG transmission occasion 3, and the first indication information indicates that the CG transmission occasion 6 is unused. After receiving the first indication information, the RAN node determines that the terminal does not use the CG transmission occasion 6, and the RAN node may further determine that the terminal does not use the CG transmission occasion 7 either.

Embodiments mentioned above in at least one embodiment may be combined in response to the solutions not conflicting. This is not limited.

The foregoing mainly describes the solutions provided in at least one embodiment from a perspective of interaction between network elements. Correspondingly, at least one embodiment further provides a communication apparatus. The communication apparatus may be the RAN node in the foregoing method embodiments, or an apparatus including the foregoing RAN node, or a component that can be configured for the RAN node. Alternatively, the communication apparatus may be the terminal in the foregoing method embodiments, or an apparatus including the foregoing terminal, or a component that can be configured for the terminal. To implement the foregoing functions, the foregoing RAN node or terminal includes corresponding hardware structures and/or software modules for implementing the functions. A person skilled in the art should be easily aware that, in combination with units and algorithm operations of the examples described in embodiments disclosed herein, at least one embodiment can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but the implementation does not go beyond the scope of embodiments described herein.

Interaction between network elements is described above by using the terminal and a network device as an example. Actually, processing performed by the terminal is not limited to being performed only by a single network element, and processing performed by the RAN node is not limited to being performed only by a single network element. For example, processing performed by the RAN node may be performed by at least one of a CU, a DU, and an RU.

In at least one embodiment, functional modules of the RAN node or the terminal may be obtained through division based on the foregoing method examples. For example, each functional module may be obtained through division based on each corresponding function, or two or more functions may be integrated into one processing module. The integrated module may be implemented in a form of hardware, or may be implemented in a form of a software functional module. In at least one embodiment, module division is an example, and is merely logical function division. In an actual implementation, there may be another division manner.

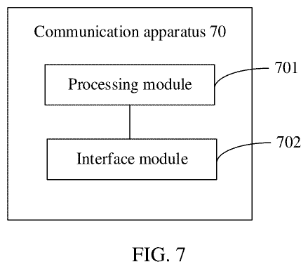

For example, in response to the functional modules being obtained through division in an integrated manner, FIG. 7 is a diagram of a structure of a communication apparatus 70. The communication apparatus 70 includes a processing module 701 and an interface module 702. The processing module 701 may also be referred to as a processing unit, and is configured to perform an operation other than receiving and sending operations. For example, the processing module 701 may be a processing circuit or a processor. The interface module 702 may also be referred to as an interface unit, and is configured to perform receiving and sending operations. For example, the interface module 702 may be an interface circuit, a transceiver machine, a transceiver, or a communication interface.

In some embodiments, the communication apparatus 70 may further include a storage module (not shown in FIG. 7), configured to store program instructions and data.

For example, the communication apparatus 70 is configured to implement a function of a terminal. For example, the communication apparatus 70 is the terminal described in the embodiment shown in FIG. 4.

The processing module 701 is configured to obtain first configuration information. The first configuration information is used to configure a reporting periodicity of first indication information, and the first indication information indicates a CG transmission occasion that is unused within a CG period or a CG transmission occasion that is used within a CG period. For example, the processing module 701 may be configured to perform S401.

The interface module 702 is configured to send the first indication information on at least one CG transmission occasion within the CG period based on the reporting periodicity. For example, the interface module 702 may be configured to perform S402.

In at least one embodiment, the reporting periodicity is N+1 or N, N represents a quantity of CG transmission occasions between two adjacent CG transmission occasions on which the first indication information is carried within the CG period, and N is an integer greater than or equal to 0; or the reporting periodicity is T, and T represents a time difference between two adjacent CG transmission occasions on which the first indication information is carried within the CG period.

In at least one embodiment, the first configuration information is further used to configure a 1^{st} CG transmission occasion on which the first indication information is carried within the CG period.

In at least one embodiment, the at least one CG transmission occasion includes a first CG transmission occasion and a second CG transmission occasion, and the first CG transmission occasion precedes the second CG transmission occasion; and a quantity of unused CG transmission occasions indicated by the first indication information carried on the first CG transmission occasion is M1, a quantity of unused CG transmission occasions indicated by the first indication information carried on the second CG transmission occasion is M2, and M1 is less than M2; or a quantity of used CG transmission occasions indicated by the first indication information carried on the first CG transmission occasion is M3, a quantity of used CG transmission occasions indicated by the first indication information carried on the second CG transmission occasion is M4, and M3 is greater than M4.

In at least one embodiment, the quantity of unused CG transmission occasions or the quantity of used CG transmission occasions is related to a buffer state of the terminal. In at least one embodiment, the first configuration information is further used to configure a first interval, the at least one CG transmission occasion includes a third CG transmission occasion, the first indication information carried on the third CG transmission occasion indicates that the unused CG transmission occasions include a fourth CG transmission occasion, and there is the first interval between the third CG transmission occasion and the fourth CG transmission occasion.

In at least one embodiment, the unused CG transmission occasions further include a CG transmission occasion following the fourth CG transmission occasion within the CG period.

In at least one embodiment, an interval between each CG transmission occasion of the at least one CG transmission occasion and a CG transmission occasion that is unused within the CG period is greater than a first threshold.

In at least one embodiment, the first configuration information is further used to configure the first threshold.

In at least one embodiment, the first configuration information is further used to configure a CG transmission occasion within the CG period.

In response to the communication apparatus 70 being configured to implement the function of the terminal, for other functions that can be implemented by the communication apparatus 70, refer to the related descriptions of the embodiment shown in FIG. 4. Details are not described again.

Alternatively, for example, the communication apparatus 70 is configured to implement a function of a RAN node. For example, the communication apparatus 70 is the RAN node in the embodiment shown in FIG. 4.

The processing module 701 is configured to output first configuration information. The first configuration information is used to configure a reporting periodicity of first indication information, and the first indication information indicates a configured grant CG transmission occasion that is unused within a CG period or a CG transmission occasion that is used within a CG period. For example, the processing module 701 may be configured to perform S401.

The interface module 702 is configured to receive the first indication information on at least one CG transmission occasion within the CG period based on the reporting periodicity. For example, the interface module 702 may be configured to perform S402.

In at least one embodiment, the reporting periodicity is N+1 or N, N represents a quantity of CG transmission occasions between two adjacent CG transmission occasions on which the first indication information is carried within the CG period, and Nis an integer greater than or equal to 0; or the reporting periodicity is T, and T represents a time difference between two adjacent CG transmission occasions on which the first indication information is carried within the CG period.

In at least one embodiment, the first configuration information is further used to configure a 1^{st} CG transmission occasion on which the first indication information is carried within the CG period.

In at least one embodiment, the at least one CG transmission occasion includes a first CG transmission occasion and a second CG transmission occasion, and the first CG transmission occasion precedes the second CG transmission occasion; and a quantity of unused CG transmission occasions indicated by the first indication information carried on the first CG transmission occasion is M1, a quantity of unused CG transmission occasions indicated by the first indication information carried on the second CG transmission occasion is M2, and Ml is less than M2; or a quantity of used CG transmission occasions indicated by the first indication information carried on the first CG transmission occasion is M3, a quantity of used CG transmission occasions indicated by the first indication information carried on the second CG transmission occasion is M4, and M3 is greater than M4.

In at least one embodiment, the first configuration information is further used to configure a first interval, the at least one CG transmission occasion includes a third CG transmission occasion, the first indication information carried on the third CG transmission occasion indicates that the unused CG transmission occasions include a fourth CG transmission occasion, and there is the first interval between the third CG transmission occasion and the fourth CG transmission occasion.

In at least one embodiment, the unused CG transmission occasions further include a CG transmission occasion following the fourth CG transmission occasion within the CG period.

In at least one embodiment, an interval between each CG transmission occasion of the at least one CG transmission occasion and a CG transmission occasion that is unused within the CG period is greater than a first threshold.

In at least one embodiment, the first configuration information is further used to configure the first threshold.

In at least one embodiment, the first configuration information is further used to configure a CG transmission occasion within the CG period.

In response to the communication apparatus 70 being configured to implement the function of the terminal, for other functions that can be implemented by the communication apparatus 70, refer to the related descriptions of the embodiment shown in FIG. 4. Details are not described again.

In a simple embodiment, a person skilled in the art may figure out that the communication apparatus 70 may be in a form shown in FIG. 3. For example, the processor 301 in FIG. 3 may invoke the computer-executable instructions stored in the memory 303, to enable the communication apparatus 70 to perform the method in the foregoing method embodiments.

For example, functions/implementation processes of the processing module 701 and the interface module 702 in FIG. 7 may be implemented by the processor 301 in FIG. 3 by invoking the computer-executable instructions stored in the memory 303. Alternatively, a function/an implementation process of the processing module 701 in FIG. 7 may be implemented by the processor 301 in FIG. 3 by invoking the computer-executable instructions stored in the memory 303, and a function/an implementation process of the interface module 702 in FIG. 7 may be implemented by using the communication interface 304 in FIG. 3.

One or more of the foregoing modules or units may be implemented by using software, hardware, or a combination thereof. In response to any one of the foregoing modules or units being implemented by software, the software exists in a form of a computer program instruction, and is stored in the memory. The processor may be configured to execute the program instruction and implement the foregoing method procedure. The processor may be built into a SoC (system on chip) or an ASIC, or may be an independent semiconductor chip. In addition to the core configured to perform calculation or processing by executing a software instruction, the processor may further include a necessary hardware accelerator, for example, a field programmable gate array (field programmable gate array, FPGA), a PLD (programmable logic device), or a logic circuit that implements a dedicated logic operation.

In response to the foregoing modules or units being implemented by using hardware, the hardware may be any one or any combination of a CPU, a microprocessor, a digital signal processing (digital signal processing, DSP) chip, a microcontroller unit (microcontroller unit, MCU), an artificial intelligence processor, an ASIC, a SoC, an FPGA, a PLD, a dedicated digital circuit, a hardware accelerator, or a non-integrated discrete device, and the hardware may run necessary software or does not depend on software to perform the foregoing method procedures.

Optionally, at least one embodiment further provides a chip system. The chip system includes at least one processor and an interface. The at least one processor is coupled to a memory via an interface, and in response to the at least one processor executing a computer program or instructions in the memory, the method in any one of the foregoing method embodiments is performed. In at least one embodiment, the chip system further includes the memory. Optionally, the chip system may include a chip, or may include a chip and another discrete component. This is not specifically limited in at least one embodiment.

Optionally, at least one embodiment further provides a computer-readable storage medium. All or some of the procedures in the foregoing method embodiments may be implemented by a computer program instructing related hardware. The program may be stored in the computer-readable storage medium. In response to the program being executed, the procedures in the foregoing method embodiments may be included. The computer-readable storage medium may be an internal storage unit of the communication apparatus according to any one of the foregoing embodiments, for example, a hard disk drive or an internal memory of the communication apparatus. Alternatively, the computer-readable storage medium may be an external storage device of the communication apparatus, for example, a plug-in hard disk drive, a smart media card (smart media card, SMC), a secure digital (secure digital, SD) card, or a flash card (flash card) that is configured on the communication apparatus. Further, the computer-readable storage medium may include both an internal storage unit and an external storage device of the communication apparatus. The computer-readable storage medium is configured to store the computer program and store other programs and data that are required by the communication apparatus. The computer-readable storage medium may be further configured to temporarily store data that has been output or is to be output.

Optionally, at least one embodiment further provides a computer program product. All or some of the procedures in the foregoing method embodiments may be implemented by a computer program instructing related hardware. The program may be stored in the computer program product. In response to the program being executed, the procedures in the foregoing method embodiments may be included.

Optionally, at least one embodiment further provides computer instructions. All or some of the procedures in the foregoing method embodiments may be implemented by the computer instructions instructing related hardware (for example, a computer, a processor, a RAN node, or a terminal). A program may be stored in the computer-readable storage medium or the computer program product.

Optionally, at least one embodiment further provides a communication system, including the RAN node and the terminal in the foregoing embodiments.

The foregoing descriptions about implementations allow a person skilled in the art to clearly understand that, for the purpose of convenient and brief descriptions, division of the foregoing functional modules is used as an example for illustration. During actual application, the foregoing functions can be allocated to different modules and implemented as required, to be specific, an inner structure of an apparatus is divided into different functional modules to implement all or some of the functions described above.

In the several embodiments provided in at least one embodiment, the disclosed apparatus and method may be implemented in other manners. For example, the described apparatus embodiment is merely an example. For example, the module or division into the units is merely logical function division and may be other division in actual implementation. For example, a plurality of units or components may be combined or integrated into another apparatus, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may be one or more physical units, may be located in one place, or may be distributed on different places. Some or all of the units may be selected based on actual requirements to achieve the objectives of the solutions of embodiments.

In addition, functional units in at least one embodiment may be integrated into one processing unit, each of the units may exist alone physically, or two or more units are integrated into one unit. The integrated unit may be implemented in a form of hardware, or may be implemented in a form of a software functional unit.

The foregoing descriptions are merely specific implementations of at least one embodiment, but are not intended to limit the protection scope of embodiments described herein. Any variation or replacement within the technical scope disclosed in at least one embodiment shall fall within the protection scope of embodiments described herein. Therefore, the protection scope of embodiments described herein shall be subject to the protection scope of the claims. CLAIMS

1. An information transmission method, wherein the method comprises:
obtaining first configuration information, wherein the first configuration information is usable to configure a reporting periodicity of first indication information, and the first indication information is usable to indicate a configured grant (CG) transmission occasion that is unused within a CG period or a CG transmission occasion that is used within a CG period; and
sending the first indication information on at least one CG transmission occasion within the CG period based on the reporting periodicity.

2. The method according to claim 1, wherein:
the reporting periodicity is N+1 or N, N represents a quantity of CG transmission occasions between two adjacent CG transmission occasions on which the first indication information is carried within the CG period, and Nis an integer greater than or equal to 0; or
the reporting periodicity is T, and T represents a time difference between two adjacent CG transmission occasions on which the first indication information is carried within the CG period.

3. The method according to claim 1, wherein the first configuration information is further usable to configure a 1^{st} CG transmission occasion on which the first indication information is carried within the CG period.

4. The method according to claim 1, wherein the at least one CG transmission occasion includes a first CG transmission occasion and a second CG transmission occasion, and the first CG transmission occasion precedes the second CG transmission occasion;
wherein a quantity of unused CG transmission occasions indicated by the first indication information carried on the first CG transmission occasion is M1, a quantity of unused CG transmission occasions indicated by the first indication information carried on the second CG transmission occasion is M2, and Ml is less than M2; or a quantity of used CG transmission occasions indicated by the first indication information carried on the first CG transmission occasion is M3, a quantity of used CG transmission occasions indicated by the first indication information carried on the second CG transmission occasion is M4, and M3 is greater than M4.

5. The method according to claim 1, wherein the method is applied to a terminal, and:
the quantity of unused CG transmission occasions or the quantity of used CG transmission occasions is related to a buffer state of the terminal.

6. The method according to claim 1, wherein the first configuration information is further usable to configure a first interval, the at least one CG transmission occasion includes a third CG transmission occasion, the first indication information carried on the third CG transmission occasion is usable to indicate that the unused CG transmission occasions include a fourth CG transmission occasion, and there is the first interval between the third CG transmission occasion and the fourth CG transmission occasion.

7. The method according to claim 1, wherein an interval between each CG transmission occasion of the at least one CG transmission occasion and a CG transmission occasion that is unused within the CG period greater than a first threshold.

8. An apparatus, comprising:
one or more processors to execute instructions causing the apparatus to:
obtain first configuration information, wherein the first configuration information is used to configure a reporting periodicity of first indication information, and the first indication information indicates a configured grant (CG) transmission occasion that is unused within a CG period or a CG transmission occasion that is used within a CG period; and
send the first indication information on at least one CG transmission occasion within the CG period based on the reporting periodicity.

9. The apparatus according to claim 8, wherein
the reporting periodicity is N+1 or N, N represents a quantity of CG transmission occasions between two adjacent CG transmission occasions on which the first indication information is carried within the CG period, and Nis an integer greater than or equal to 0; or
the reporting periodicity is T, and T represents a time difference between two adjacent CG transmission occasions on which the first indication information is carried within the CG period.

10. The apparatus according to claim 8, wherein the first configuration information is further used to configure a 1^{st} CG transmission occasion on which the first indication information is carried within the CG period.

11. The apparatus according to claim 8, wherein the at least one CG transmission occasion includes a first CG transmission occasion and a second CG transmission occasion, and the first CG transmission occasion precedes the second CG transmission occasion; and
a quantity of unused CG transmission occasions indicated by the first indication information carried on the first CG transmission occasion is M1, a quantity of unused CG transmission occasions indicated by the first indication information carried on the second CG transmission occasion is M2, and Ml is less than M2; or a quantity of used CG transmission occasions indicated by the first indication information carried on the first CG transmission occasion is M3, a quantity of used CG transmission occasions indicated by the first indication information carried on the second CG transmission occasion is M4, and M3 is greater than M4.

12. The apparatus according to claim 8, wherein
the quantity of unused CG transmission occasions or the quantity of used CG transmission occasions is related to a buffer state of a terminal.

13. The apparatus according to claim 8, wherein the first configuration information is further usable to configure a first interval, the at least one CG transmission occasion includes a third CG transmission occasion, the first indication information carried on the third CG transmission occasion is usable to indicate that the unused CG transmission occasions includes a fourth CG transmission occasion, and there is the first interval between the third CG transmission occasion and the fourth CG transmission occasion.

14. The apparatus according to claim 8, wherein an interval between each CG transmission occasion of the at least one CG transmission occasion and a CG transmission occasion that is unused within the CG period is greater than a first threshold.

15. A non-transitory computer readable medium storing instructions that are executable by a computer, and the instructions comprise instructions for:
obtaining first configuration information, wherein the first configuration information is usable to configure a reporting periodicity of first indication information, and the first indication information is usable to indicate a configured grant (CG) transmission occasion that is unused within a CG period or a CG transmission occasion that is used within a CG period; and
sending the first indication information on at least one CG transmission occasion within the CG period based on the reporting periodicity.

16. The non-transitory computer readable medium according to claim 15, wherein:
the reporting periodicity is N+1 or N, N represents a quantity of CG transmission occasions between two adjacent CG transmission occasions on which the first indication information is carried within the CG period, and Nis an integer greater than or equal to 0; or
the reporting periodicity is T, and T represents a time difference between two adjacent CG transmission occasions on which the first indication information is carried within the CG period.

17. The non-transitory computer readable medium according to claim 15, wherein the first configuration information is further usable to configure a 1^{st} CG transmission occasion on which the first indication information is carried within the CG period.

18. The non-transitory computer readable medium according to claim 15, wherein the at least one CG transmission occasion on a first CG transmission occasion and a second CG transmission occasion, and the first CG transmission occasion precedes the second CG transmission occasion;
wherein a quantity of unused CG transmission occasions indicated by the first indication information carried on the first CG transmission occasion is M1, a quantity of unused CG transmission occasions indicated by the first indication information carried on the second CG transmission occasion is M2, and M1 is less than M2; or a quantity of used CG transmission occasions indicated by the first indication information carried on the first CG transmission occasion is M3, a quantity of used CG transmission occasions indicated by the first indication information carried on the second CG transmission occasion is M4, and M3 is greater than M4.

19. The non-transitory computer readable medium according to claim 15, wherein the first configuration information is further usable to configure a first interval, the at least one CG transmission occasion includes a third CG transmission occasion, the first indication information carried on the third CG transmission occasion is usable to indicate that the unused CG transmission occasions include a fourth CG transmission occasion, and there is the first interval between the third CG transmission occasion and the fourth CG transmission occasion.

20. The non-transitory computer readable medium according to claim 15, wherein an interval between each CG transmission occasion of the at least one CG transmission occasion and a CG transmission occasion that is unused within the CG period greater than a first threshold.
